(19) United States
(12) Patent Application Publication
(10) Pub. No.: US 2023/0406080 A1
(43) Pub. Date: Dec. 21, 2023

(54) Assembly and cover system for a vehicle roof, vehicle roof for a motor vehicle, and method for manufacturing an assembly for a vehicle roof

(71) Applicant: Webasto SE, Stockdorf (DE)

(72) Inventors: Julian KNÖPFLE, Stockdorf (DE); Ulrich SCHREIBER, Stockdorf (DE); Maciej KACZMAREK, Stockdorf (DE); Moritz PRADELLA, Stockdorf (DE); Johann LANG, Stockdorf (DE)

(21) Appl. No.: 18/034,979

(22) PCT Filed: Oct. 21, 2021
(86) PCT No.: PCT/EP2021/079182

§ 371 Date: May 2, 2023

(30) Foreign Application Priority Data
Nov. 6, 2020 (DE) 10 2020 129 286.4
Feb. 4, 2021 (DE) 10 2021 102 623.7

(51) Int. Cl. B60J 7/16

(52) U.S. Cl. CPC B60J 7/1642; B62D 65/02

(57) ABSTRACT

An assembly for vehicle roof has a deployable cover, a cover inside panel which is coupled to the cover, and a cover frame configured to couple the cover to the roof. The assembly has a cover receptacle unit to receive the cover and to couple the latter to the cover frame, and a cover centering unit with a centering lever and lever receptacle, configured to match one another. One centering lever and lever receptacle is coupled to the cover frame on a lateral longitudinal strut of the latter. The other of centering lever and lever receptacle is coupled to the cover inside panel so that the cover can be coupled to the cover frame by the cover receptacle unit and by inserting the centering lever is able to be centered in the lever receptacle in relation to a plane of main extent of the cover relative to the cover frame.

### CROSS-REFERENCE TO RELATED APPLICATIONS

This application is a U.S. national phase application filed under 35 U.S.C. § 371 of International Application No. PCT/EP2021/079182, filed on Oct. 21, 2021, published under WO 2022/096274 on May 12, 2022, designating the United States, which claims priority from German Patent Application Number 10 2020 129 286.4, filed on Nov. 6, 2020, and from German Patent Application Number, 10 2021 102 623.7, filed on Feb. 4, 2021, which are hereby incorporated herein by reference in their entirety for all purposes.

### FIELD

The invention relates to an assembly for a vehicle roof. The invention furthermore relates to a cover system and a vehicle roof with such an assembly. The invention moreover relates to a method for manufacturing an assembly for a vehicle roof.

### BACKGROUND

Some motor vehicles have vehicle roofs with one or a plurality of covers which, for example as permanently integrated glass elements, allow a view through the vehicle roof or are movably configured components in order to enable an opening in the vehicle roof to be selectively released and closed. In the production of such a vehicle roof, roof modules are connected to a body of the motor vehicle by means of a frame. Configuring a vehicle roof is described in document EP 2020367 A2, for example.

### SUMMARY

An object on which the invention is based is to achieve an assembly for a vehicle roof which allows a simple and cost-saving construction of a vehicle roof and also contributes to a large view through the vehicle roof. It is furthermore an object to provide a cover system and a vehicle roof with such an assembly and a method for configuring such an assembly.

The respective object is achieved by the features of the respective independent patent claims. Advantageous embodiments are specified in the dependent patent claims.

An assembly according to the invention for a vehicle roof for a motor vehicle comprises a cover for configuring a deployable and retractable roof element for the vehicle roof and a cover inside panel which is coupled to the cover. The assembly further comprises a cover frame which is configured to couple the cover to a roof body (of the motor vehicle. The assembly further comprises a cover receptacle unit which is designed to receive the cover and to couple the latter to the cover frame. The assembly also comprises a cover centering unit which comprises a centering lever and a lever receptacle, which are configured to match one another. One of centering lever and lever receptacle in terms of a longitudinal axis of the vehicle roof is coupled to the cover frame on a lateral longitudinal strut of the latter. The other of centering lever and lever receptacle is coupled to the cover inside panel so that the cover can be coupled to the cover frame by means of the cover receptacle unit and by means of inserting the centering lever is able to be centered in the lever receptacle in relation to a plane of main extent of the cover relative to the cover frame, an aligned and operationally ready state of the assembly being able to be formed thereby.

By means of the assembly described, a construction of a vehicle roof which enables a particularly large view through the vehicle roof is able to be implemented in a simple and inexpensive way. By means of the assembly described, reliable and precise cover centering of the retractable and deployable cover can take place in particular. The cover is provided in particular to be disposed in a front region of the vehicle roof.

In the context of this description, terms, such as “top”, “bottom”, “front” and “rear”, relate to an operationally ready orientation of an associated motor vehicle which comprises a vehicle roof having a design embodiment of the assembly. Accordingly, the longitudinal axis of the vehicle roof extends between a front and a rear of the motor vehicle, and can also represent a customary forward travel direction.

According to an embodiment of the assembly, the centering lever is configured so as to be integral to the cover inside panel or the cover frame, and is shaped as a bent tab. As an alternative to the integral configuration, the centering lever can be configured as a separate and optionally multi-part component and be connected to the cover inside panel or the cover frame in a force-fitting, form-fitting and/or materially integral manner. Corresponding potential design embodiments can also be provided for the lever receptacle. The lever receptacle is preferably configured so as to be sleeve-shaped. Furthermore, the centering lever and/or the lever receptacle can be configured such that they are displaceable or adjustable relative to one another to a predefined extent so that a certain positioning tolerance is provided.

According to a further embodiment of the assembly, the cover centering unit comprises a vibration-damping element which is coupled to the lever receptacle and in terms of a coupled state of the cover to the cover frame counteracts any vibration of the centering lever. For example, the vibration-damping element is configured as a plastic overmolding, or comprises such a plastic overmolding, which is disposed on an internal side of the lever receptacle that faces the centering lever. In this instance, the plastic overmolding in terms of a coupled state of the cover to the cover frame is disposed between the centering lever and the lever receptacle, and contributes toward a stable and reliable coupling of the cover to the cover frame. Moreover, this counteracts rattling. Alternatively or additionally, the vibration-damping element can configure a portion of the lever receptacle and is configured, for example, as a tongue or tab which from the internal side extents inward and, in contact with the centering lever, can act in a vibration-damping manner.

According to a preferred embodiment of the assembly, the cover is configured as a deployable and retractable roof element so as to be able to be raised and lowered on a rear edge, wherein the cover receptacle unit is disposed on a front cross strut of the cover frame and, in a coupled state of the cover to the cover frame, configures a pivot axis of the cover. The centering lever and the lever receptacle in terms of the respective orientation, position and/or shape thereof are configured so as to be adapted to the pivot axis.

Alternatively or additionally, the centering lever and the lever receptacle in terms of the orientation, position and/or shape thereof can be configured so as to be adapted to a convexity of the cover. Furthermore, the centering lever when interacting with the lever receptacle can configure a securing unit for the cover with a view to a frontal or side impact.

For example, the centering lever and the lever receptacle have in each case an elongate, slightly bent shape which follows a radial track segment which is predefined by the pivot axis and the convexity of the cover. Moreover, the cover centering unit is also in particular configured in a predefined manner with a view to a size, a weight and/or a material of the cover, so as to establish a reliable and stable cover centering.

According to a preferred embodiment of the assembly, the cover receptacle unit has a receptacle element having a receptacle opening, and a plug-in element, wherein the plug-in element and the receptacle opening are configured so as to be adapted to one another. One of receptacle element and plug-in element, in terms of the longitudinal axis of the vehicle roof, is coupled to the cover frame at a front cross strut of the latter. The other of receptacle element and plug-in element is coupled to the cover inside panel such that the cover is able to be coupled to the cover frame by means of plugging-in the plug-in element into the receptacle opening.

A cover system according to the invention for a vehicle roof has an embodiment of the assembly described above and a further cover, each of which is coupled to the cover frame. In terms of the longitudinal axis of the vehicle roof, the cover of the assembly thus forms a front, deployable and retractable roof element and the further cover forms a rear, in particular fixed, roof element for the vehicle roof. Alternatively, the cover of the assembly can form the rear cover and the further cover can form the front cover of a two-cover system. Furthermore, the cover system can alternatively only have the cover described conjointly with the assembly and implement a single-cover system. For example, the cover can be made so large that it extends over the entire length of the vehicle or over the available length of the vehicle roof.

A vehicle roof according to the invention for a motor vehicle comprises an embodiment of the assembly described above or the cover system described above with two covers, which is coupled to a roof body of the motor vehicle by means of the cover frame.

Because the cover system and the vehicle roof comprise an embodiment of the assembly, features and properties of the assembly described above are also disclosed for the cover system and the vehicle roof and vice versa.

A method according to the invention for producing an assembly for a vehicle roof for a motor vehicle comprises providing a cover and a cover inside panel and a cover frame which is designed to couple the cover to a roof body of the motor vehicle by means of the cover inside panel. The method further comprises providing a cover receptacle unit, which is designed to receive and couple the cover to the cover frame. The method further comprises providing a cover centering unit with a centering lever and a lever receptacle, the centering lever and the lever receptacle being configured to match one another. One of centering lever and lever receptacle in terms of a longitudinal axis of the vehicle roof is coupled to the cover frame on a lateral longitudinal strut of the latter. The other of centering lever and lever receptacle is coupled to the cover inside panel. The invention further comprises coupling the cover inside panel to the cover and coupling the cover to the cover frame by means of the cover receptacle unit. The method also includes inserting the centering lever into the lever receptacle and thereby centering the cover relative to the cover frame in terms of a plane of main extent of the cover and forming an aligned and operationally ready state of the assembly.

In particular, the method can further comprise providing the cover receptacle unit which, as described above, comprises a receptacle element with a receptacle opening and an insertion element. The cover is then coupled to the cover frame by means of the cover receptacle unit by inserting the insertion element into the receptacle opening of the receptacle element.

Because the method relates in particular to configuring an embodiment of the assembly described above, features and properties of the assembly described above are also disclosed for the method and vice versa.

A passive cover hanging arrangement at the front of the vehicle roof, which in a simple and reliable manner can receive and center a deployable and retractable cover is able to be implemented by means of the method described and the previously described assembly. A front part of the cover no longer has to be screwed on, but can now just be plugged in.

It has been recognized in the context of the present invention that conventional roof systems having a raisable cover by means of one or a plurality of cover screws are fastened to a bearing point fixedly assembled on the frame. Therefore, accessibility to the screws has to be guaranteed. Accordingly, a respective screw attachment point may only be so far forward as can be reached for reliable assembling. This accessibility is restricted inter alia by a geometry of the cover frame, a roof body of the vehicle roof and/or further components such as a cowl.

Owing to such restrictions, a cover cannot be designed to be significantly longer, or a view through said cover cannot be substantially enlarged, because a distance to a respective screw/rotation axis otherwise becomes excessive and a front edge of the cover, in particular in a deployable roof system, plunges excessively. Accordingly, it is also not possible to configure a desirable design of such a cover, in which the cover extends to a windshield of the motor vehicle, for example, and permits a view up to said windshield.

A particularly large view through the vehicle roof can be established by means of the assembly described, said view potentially extending close to the upper edge of the windshield of the motor vehicle. Moreover, reliable centering and secure supporting of such a cover can be established by means of the assembly. Therefore, the assembly enables in particular the configuration of a panorama vehicle roof according to a so-called “top-load-front-tilt” roof in combination with a ventilation concept. The assembly contributes in particular toward reliable X-(Y-)centering, the latter interacting in a particularly advantageous manner with the cover hanging concept at the front on the front cover, which is able to be implemented by the cover receptacle unit. The vehicle longitudinal axis here can represent an X-direction, while a Y-direction is oriented within a horizontal plane perpendicular to the latter. From the cover inside panel, a bent tab or a separate additional part can form the centering lever and be guided in an overmolded receptacle fixed to the frame on the cover frame, said receptacle forming the lever receptacle. Such a cover centering is able to be manufactured inexpensively and makes it possible for a particularly large view through the vehicle roof to be configured.

### BRIEF DESCRIPTIONS OF THE DRAWINGS

Exemplary embodiments of the invention are explained in more detail below with reference to the schematic drawings. In the drawings:

FIG. 1 shows a vehicle roof for a motor vehicle in a perspective view;

FIGS. 2-3 show an exemplary embodiment of a cover system for the vehicle roof in a respective perspective view;

FIGS. 4-5 show a front portion of the cover system in a respective lateral view;

FIG. 6 shows an exemplary embodiment of a cover receptacle unit of the cover system in a perspective view;

FIG. 7 shows an exemplary embodiment of components of the cover receptacle unit in a perspective view;

FIGS. 8-10 show a front cover of the cover system in a respective lateral view;

FIG. 11 shows an exemplary embodiment of a cover centering unit of the cover system in a lateral view;

FIG. 12 shows the front cover with the cover centering unit in a lateral view;

FIG. 13 shows an exemplary embodiment of a tilting mechanism of the cover system in a perspective view;

FIGS. 14-17 show the tilting mechanism in further views;

FIG. 18 shows an exemplary embodiment of a drive unit of the cover system in a perspective view;

FIGS. 19-25 show the drive unit in further views;

FIG. 26 shows the cover system in a schematic top view;

FIG. 27 shows an exemplary embodiment of a sealing assembly of the cover system in a perspective view;

FIGS. 28-29 show the sealing assembly in further views;

FIGS. 30-38 show different views and positions during the production of the sealing assembly;

FIGS. 39-40 show exemplary embodiments of a reinforcement assembly of the cover system in a respective perspective view;

FIG. 41 shows an illustration of relative offset positions of the cover system in terms of a vertical direction, and

FIG. 42 shows the cover system in a schematic plan view.

Elements of identical construction or function are identified with the same reference symbols in all the figures. For reasons of clarity, it is possible that not all of the elements shown are identified with associated reference signs in all of the figures.

### DETAILED DESCRIPTION

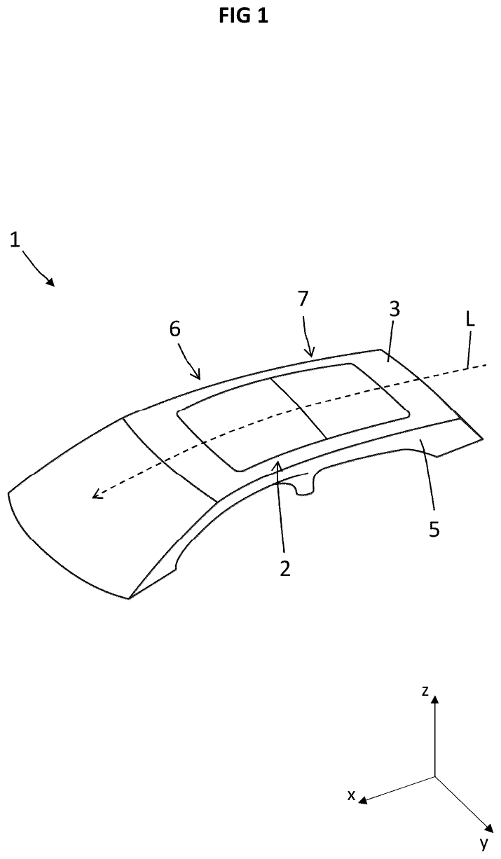

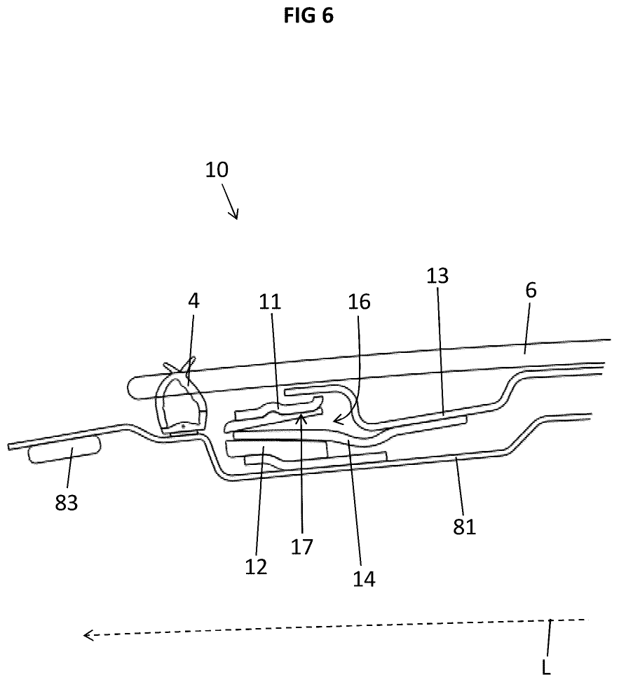

FIG. 1 schematically shows a vehicle roof 1 for a motor vehicle in a perspective view. The vehicle roof 1 comprises a cover system 2 which by means of a cover frame 8 is coupled to a roof body 5 of the motor vehicle. The cover frame 8 is coupled to the roof body 5 of the vehicle roof 1 by means of a cover frame support 83 (see also FIGS. 6, 24 and 27). In particular, the cover frame 8 also implements a carrier frame, for example for seals or mechanical components, and can be designed in one piece or in multiple pieces. Said cover frame 8 can have plastic and/or steel segments and in the top view have a U-shape, an A-shape, an 8-shape or other shapes for supporting one or a plurality of covers.

The cover system 2 comprises a first, front cover 6 and a second, rear cover 7 in terms of a longitudinal axis L of the vehicle roof 1. The longitudinal axis L also forms a longitudinal axis of the cover system 2 and of the motor vehicle and, according to the illustrated direction of the arrow, also represents a normal direction of travel of the motor vehicle that is ready for operation.

Terms such as “top”, “bottom”, “front”, “rear”, “top side”, “bottom side”, “front edge”, “rear edge” relate to an orientation of the respective component according to an operational configuration of the vehicle roof 1 on a motor vehicle, as indicated in FIG. 1.

As will be explained with reference to the following figures, the cover system 2 enables a simple and inexpensive construction of the vehicle roof 1 and also allows a particularly large view through the vehicle roof 1. The front cover 6 is configured as a deployable and retractable roof element, while the rear cover 7 implements a fixed roof element. The front cover 6 is thus configured such that it can be raised or deployed at a rear edge 9 that faces the rear cover 7, so that a ventilation position can be established in order to provide a ventilation function for the vehicle interior of the motor vehicle. In particular, both covers 6 and 7 are made of glass or a transparent plastic, such as acrylic glass, and allow a particularly large view through the vehicle roof 1. Furthermore, the covers 6 and 7 can be made of polycarbonate, toughened safety glass, or partially toughened glass or can comprise the aforementioned. Both a single-layer as well as a double-layer or multi-layer structure of the covers 6 and/or 7 are possible.

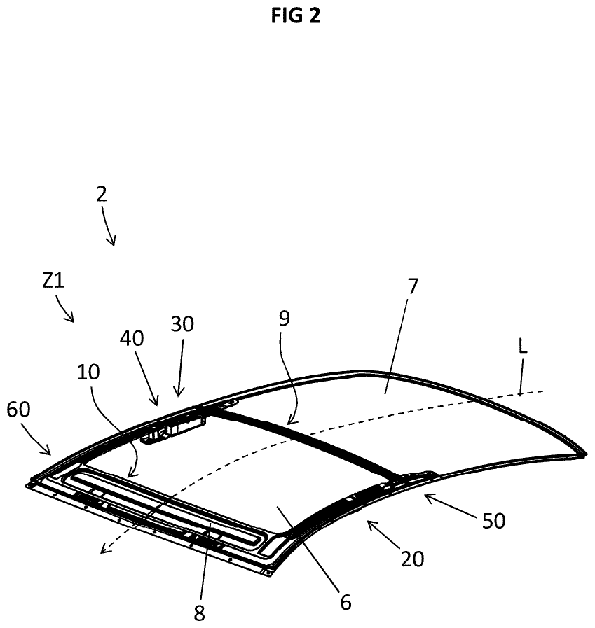

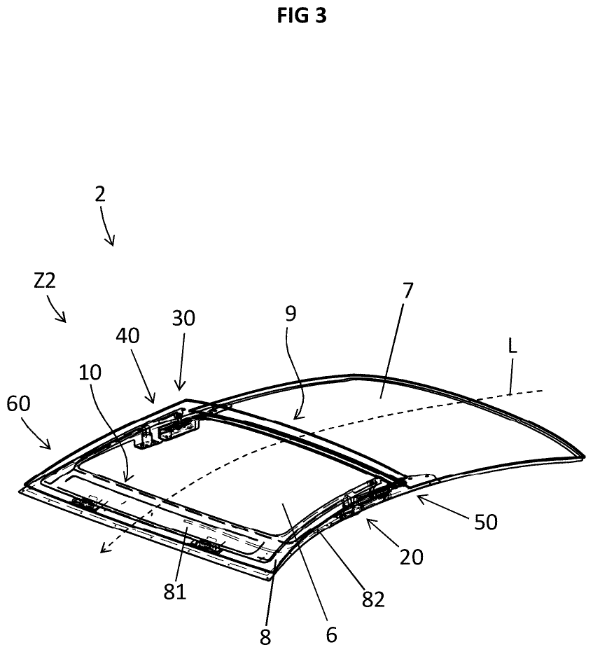

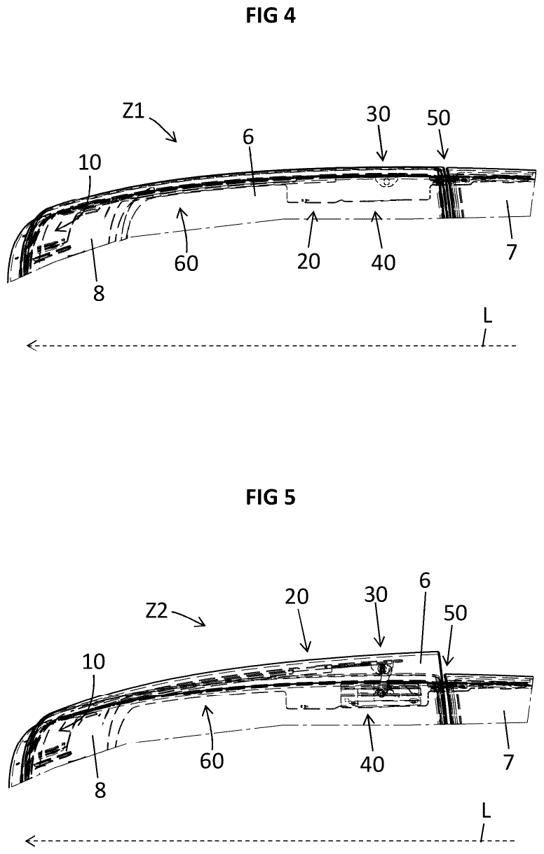

FIGS. 2 and 3 each show different states of the cover system 2 in perspective views. FIG. 2 shows the cover system 2 in a first state or a first position Z1, in which the front cover 6 is closed or retracted. FIG. 3 shows the cover system 2 in a second state or a second position Z2, in which the front cover 6 is opened or deployed. FIGS. 4 and 5 show further views of the front cover 6 in a retracted and a deployed position Z1 and Z2. A lateral view of a front section of the cover system 2 is illustrated in each case. FIG. 6 shows the cover receptacle unit 10 in a perspective view from below, as seen from the vehicle interior. The cover 6 forms the deployable and retractable roof element for the vehicle roof 1. A peripheral cover seal 4 is disposed between the cover 6 and the cover frame 8. A cover inside panel 13 is coupled to the cover 6 on a lower side of the latter. The cover frame 8 is designed to couple the cover 6 to the roof body 5 of the motor vehicle by means of the cover inside panel 13. The cover receptacle unit 10 comprises a receptacle element 11 with a receptacle opening 16 which, in terms of the longitudinal axis L, is connected to the cover frame 8 on a front cross strut 81 of the latter. In this case, the receptacle element 11 can be coupled to the cover frame 8 in a force-fitting, form-fitting and/or cohesive manner. The receptacle element 11 can be designed in one piece with the cover frame 8.

The cover receptacle unit 10 further comprises an insertion element 14, which is coupled to the cover inside panel 13. The insertion element 14 can in particular be designed in one piece with the cover inside panel 13 and shaped as a bent tab. Alternatively, the insertion element 14 is designed as a separate component and is coupled to the cover inside panel 13 in a force-fitting, form-fitting and/or materially integral manner. The cover inside panel 13 can also be made in one piece or in multiple pieces.

The insertion element 14 and the receptacle opening 16 are designed to match one another, so that the cover 6 can be coupled to the cover frame 8 by inserting the insertion element 13 into the receptacle opening 16. As a result, a screw-free state of the cover 6 that is already ready for operation can be formed on the front cross strut 81 of the cover frame 8.

The receptacle element is U-shaped in terms of the partial cross section illustrated in FIG. 6 and implements an insertion pocket for the insertion element 14. For unlocking, the cover receptacle unit 10 has a vibration-damping element in the form of a plastic insert or a plastic overmolding 12 which in the region of the receptacle opening 16 is configured on an inside 17 of the receptacle element 11. The plastic overmolding 12 has a wedge shape and in terms of a coupled state of the cover 6 to the cover frame 8 is disposed within the receptacle opening 16 between the receptacle element 11 and the insertion element 14, and exerts a holding force on the insertion element 14. The wedge shape acts like a spring and provides a certain amount of pretension, so that rattling or moving of the inserted insertion element 14 is counteracted.

In particular, the plastic insert or the plastic overmolding 12 can be configured from a plastic, such as polyoxymethylene (POM), which counteracts creaking during operation and moreover has advantageous sliding properties that can have a beneficial effect on an assembly process. Moreover, due to its softness, such a plastic can enable tolerance compensation for the components to be coupled. In addition, rib elements can also be provided on a sliding surface of the plastic.

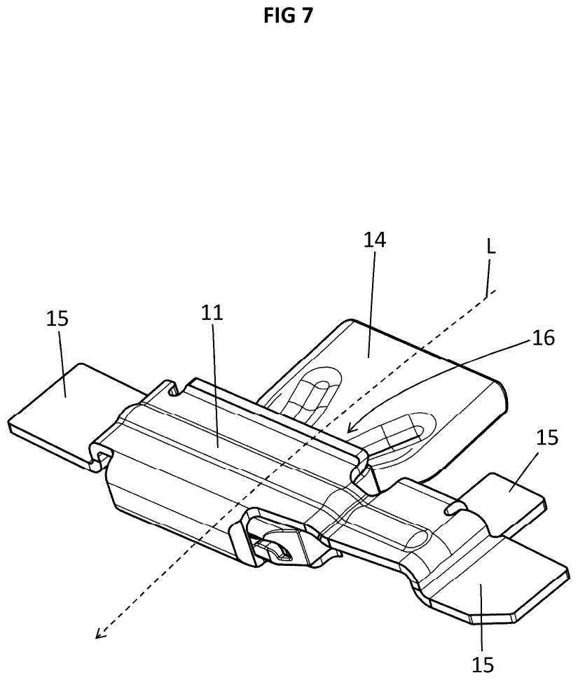

The cover receptacle unit 10 can have, in particular, two or a plurality of receptacle elements 11 and insertion elements 14, which are in each case disposed and/or configured so as to be spaced apart along the front cross strut 81 of the cover frame 8 so that, in terms of a coupled state of the cover 6 to the cover frame 8, respective insertion elements 14 are inserted in associated receptacle elements 11. A respective receptacle element 11 and insertion element 14 can be designed according to FIG. 7. Attachment wings 15 can be provided for attaching the receptacle element 11 to the cover frame 8. By means of the attachment wings 15, the receptacle element 11 can be reliably and stably connected to the cover frame 8 in a force-fitting, form-fitting and/or materially integral manner, for example by means of adhesive bonding and/or welding.

In particular, by means of such an assembly and the cover receptacle unit 10 in the front area of the cover frame 8, the deployable and retractable cover 6 can be assembled without screws. The cover 6 can be easily and reliably coupled to the cover frame 8 by virtue of the plug-in concept implemented by the cover receptacle unit 10. Because screws and complex bearing elements can be dispensed with on a front side of the cover 6, a rotation or pivot axis of the front cover 6 can be configured relatively far on a cover front edge, since no screws have to be accessed during assembly. The cover 6 can thus extend to a windshield of the motor vehicle and contribute toward the greatest possible view.

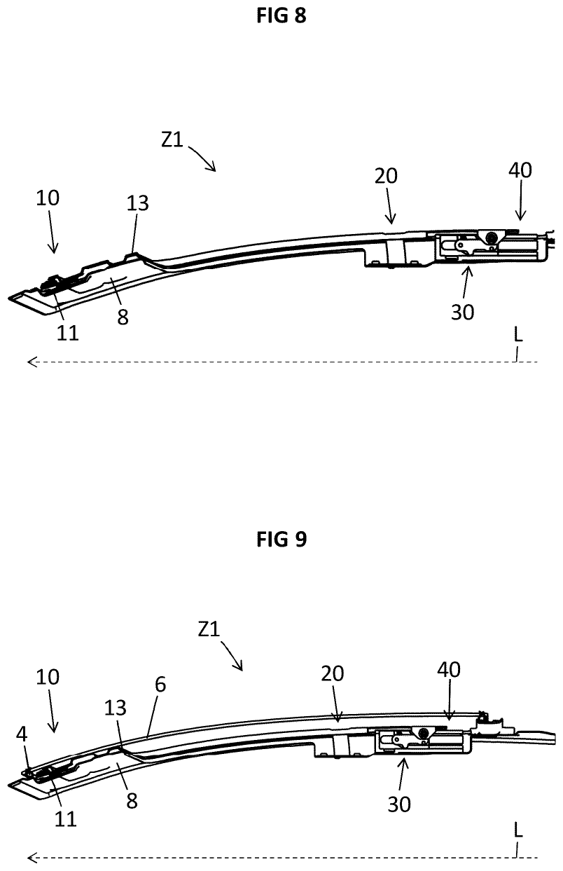

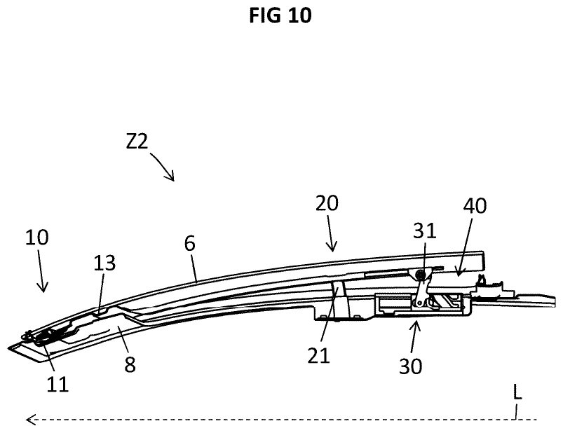

FIGS. 8 to 10 illustrate a retracted or a deployed position Z1 or Z2 of the cover 6 in further lateral views.

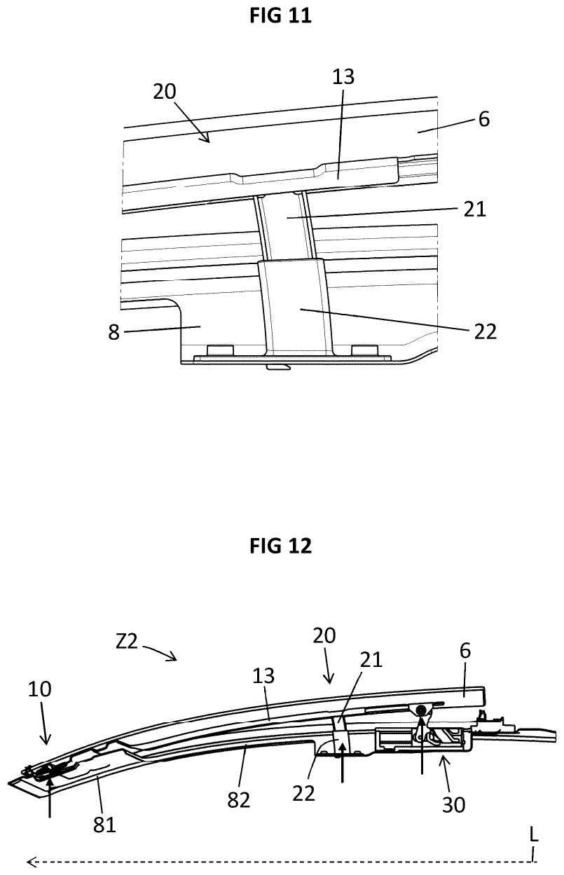

The cover system 2 also has a cover centering unit 20, which includes a centering lever 21 and a lever receptacle 22, which are designed to match one another (see FIGS. 11-12).

The lever receptacle 22 is configured to be sleeve-shaped and coupled, for example screwed, to the cover frame 8 on a lateral longitudinal strut 82 of the latter. The centering lever 21 is coupled to the cover inside panel 13 and is configured, for example, in one piece with the cover inside panel 13 and is shaped as a bent tab. The cover 6 can be coupled to the cover frame 8 by means of the cover receptacle unit 10 and, by means of inserting the centering lever 21, in terms of a plane of main extent of the cover 6 can be centered in the lever receptacle 22 relative to the cover frame 8. An aligned and operational state of the cover 6 in the cover system 2 can thus be established.

A respective plane of main extent of the cover 6 and of the cover 7 extends, apart from existing cover convexities, essentially parallel to the vehicle roof 1 and perpendicular to a vertical direction. With regard to FIG. 1, the planes of main extent of the covers 6 and 7 thus extend within the x-y plane, while the z-direction represents a vertical direction of the operationally ready motor vehicle.

Like the cover receptacle unit 10, the cover centering unit 20 can also include a vibration-damping element which is coupled to the lever receptacle 22 and is designed, for example, as a plastic overmolding on an inside of the lever receptacle 22 that faces the centering lever 21. The plastic overmolding in terms of a coupled state of the cover 6 to the cover frame 8 is thus disposed between the centering lever 21 and the lever receptacle 22 and contributes toward a secure and low-noise footing of the cover 6.

The cover centering unit 20 is configured in a way that is matched in particular in terms of the rotation axis or pivot axis of the front cover 6. This can comprise an orientation, a position and/or a shape of the centering lever 21 and the lever receptacle 22. Alternatively or additionally, the centering lever 21 and the lever receptacle 22 are configured to match a convexity of the cover 6 in terms of their alignment, their position and/or their shape. The centering lever 21 and the lever receptacle 22 are preferably designed in such a way that they follow a radial path segment which is predefined by the convexity but in particular by the pivot axis of the cover 6 (see FIGS. 11-12).

A position of the cover centering unit 20 is preferably predefined as a function of the load to be carried by the cover 6 and other elements interacting with the cover centering unit 20. This relates, for example, to a tilting mechanism 30 which is coupled to the cover 6 for deploying and retracting the latter. In FIG. 12, the positions that contribute significantly toward the mounting and alignment of the cover 6 according to the illustrated embodiment are indicated by upward-directed arrows.

The cover centering unit 20 forms a concept for centering the cover predominantly in the x-direction or in the direction of the longitudinal axis L in a simple and reliable manner. In addition, it contributes toward alignment in the y-direction or perpendicular to the longitudinal axis L and parallel to the main plane of extent of the cover 6. Positioning in the Z-direction is predominantly predefined by means of the cover receptacle unit 10, which also defines the location of the pivot axis of the cover 6 as the starting point for assembly. Thus, by means of the cover receptacle unit 10 and the cover centering unit 20, a reliable and beneficial cover suspension concept for the deployable and retractable front cover 6 can be realized.

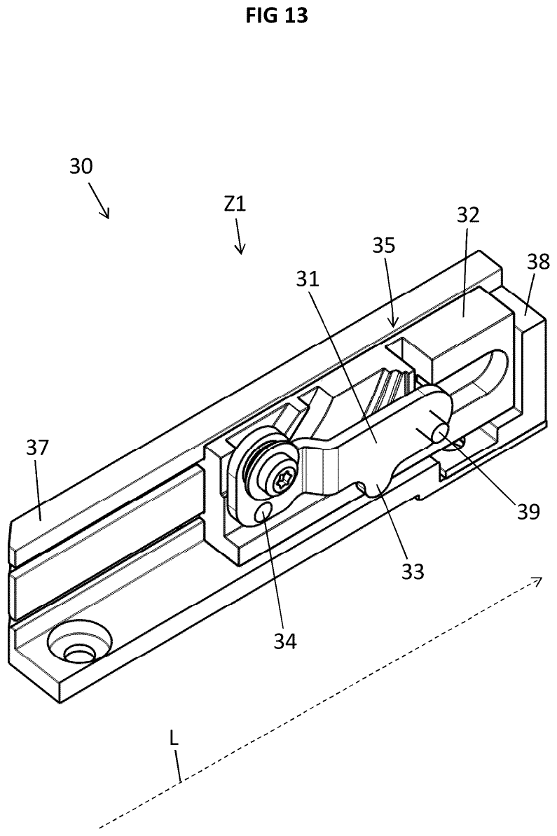

The cover system 2 furthermore comprises a tilting mechanism 30 which interacts advantageously, in particular when interacting with the cover receptacle unit 10 and the cover centering unit 20 (see FIG. 12). An embodiment of the tilting mechanism 30 is shown in FIGS. 13-17 in different views.

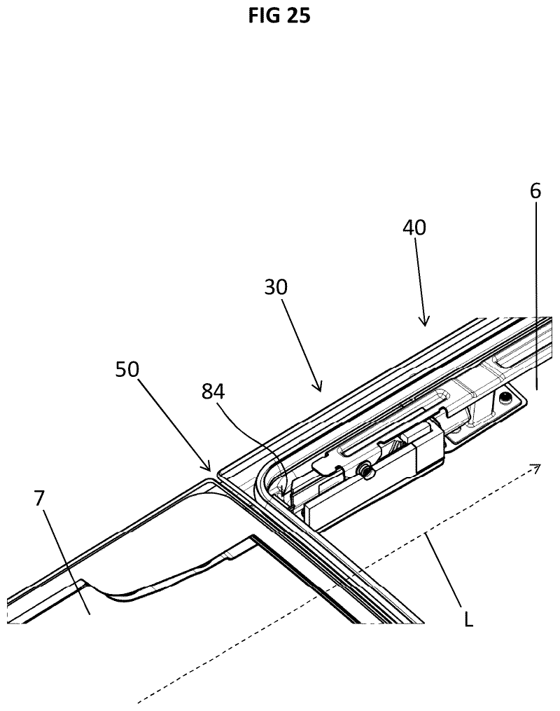

The tilting mechanism 30 comprises a deployment lever 31, a sliding guide 32 and a slotted guide 37. The deployment lever 31 is coupled to the sliding guide 32 in a pivotable manner on the one hand and therefore has a first pivot axis 51. On the other hand, the deployment lever 31 is pivotably coupled to the cover inside panel 13 and therefore has a second pivot axis S2. The sliding guide 32 by means of the slotted guide 37 is furthermore coupled to the cover frame 8 so that the sliding guide 32 in terms of the longitudinal axis L is designed to be displaceable relative to the cover frame (see also FIG. 25).

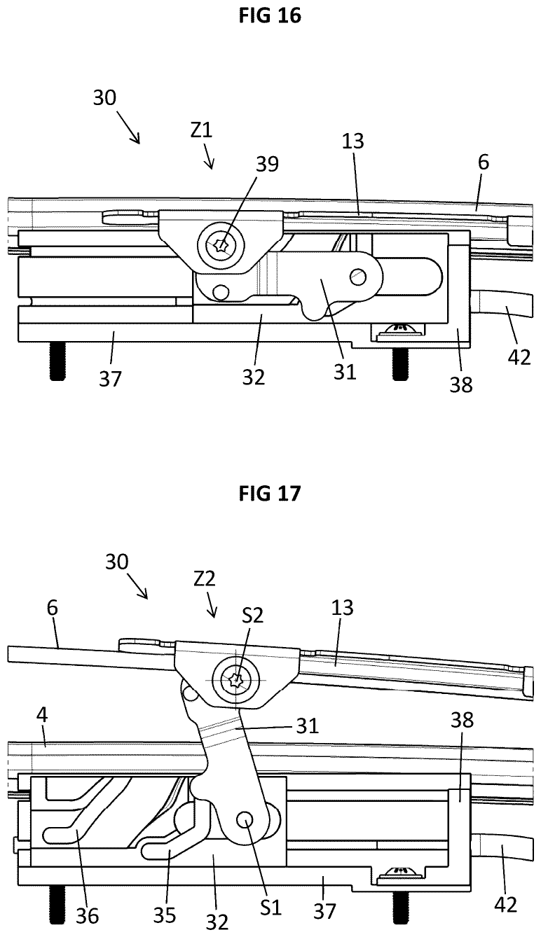

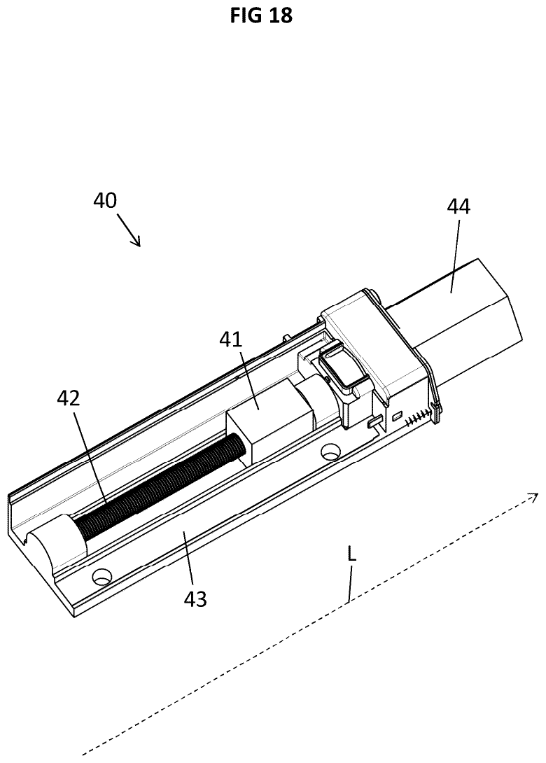

The cover 6 can be adjusted between the first, retracted position Z1 and the second, deployed position Z2 by means of the tilting mechanism 30. The tilting mechanism 30 is designed in such a way that the second pivot axis S2 is fixed in position relative to the cover 6 and the first pivot axis S1 can be displaced relative to the sliding guide 32 when the cover 6 is transferred from the first position Z1 to the second position Z2 and, when the second position Z2 is reached, is fixed in position relative to the sliding guide 32 (see FIGS. 16 and 17).

The deployment lever 31 has a first, a second and a third coupling pin 33, 34 and 39. The sliding guide 32 has a first and a second slotted guide track 35 and 36, in which the respective coupling pins 33 and 34 engage. The first coupling pin 33 is correspondingly mounted so as to be guidable in the first slotted guide track 35 and the second coupling pin 34 is correspondingly mounted so as to be guidable in the second slotted guide track 36, so that the transfer of the cover 6 from the first position Z1 to the second position Z2 and back is guided by a slotted guide.

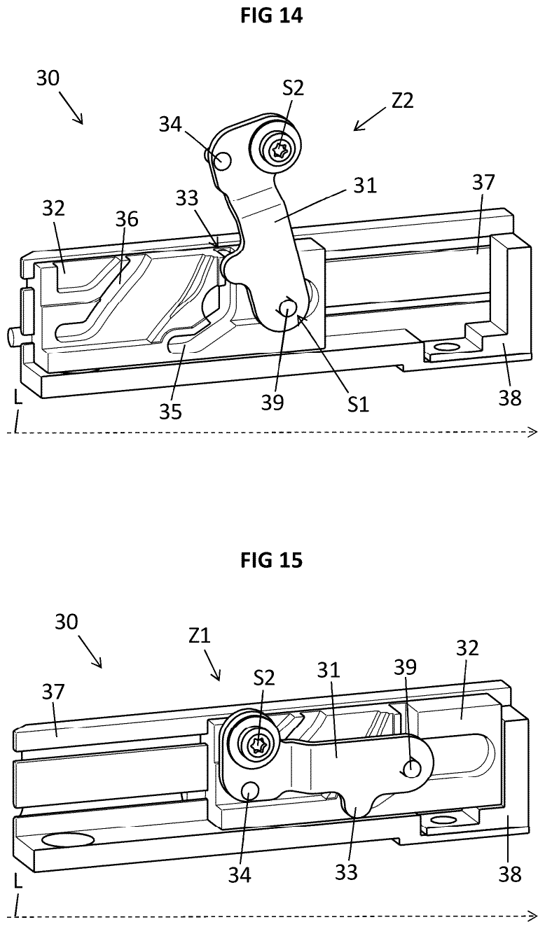

In particular, the second slotted guide track 36 is designed to be open at the top, so that the second coupling pin 34 can decouple from the second slotted guide track 36 when the deployment lever 31 is raised and the second position Z2 is established. The first coupling pin 33 remains coupled in the first slotted guide track 35. When the deployment lever 31 is retracted and the first position Z1 is established, the second coupling pin 34 couples back into the second slotted guide track 36 again (see FIGS. 14 and 15). In terms of a vertical direction perpendicular to a main plane of extent of the cover 6, the second coupling pin 34, when transferring the cover 6 from the first position Z1 to the second position Z2, is thus disposed above the first coupling pin 33.

The third coupling pin 39 on a side of the deployment lever 31 that lies opposite the first and the second coupling pin 33 and 34 extends into a slotted guide track 371 of the slotted guide 37. The third coupling pin 39 is correspondingly mounted so as to be guidable in the slotted guide track 371 of the slotted guide 37. The slotted guide track 371 of the slotted guide 37 in terms of the longitudinal axis L is delimited in a predefined manner on both sides and establishes a respective terminal detent for the third coupling pin 39 to form the first and the second position Z1, Z2 of the cover 6. Moreover, the third coupling pin 39 forms the first pivot axis S1 of the deployment lever 31.

The tilting mechanism 30 moreover includes one or a plurality of detent elements or interacts with adjacent components that serve as detent elements to provide a predefined limited travel. The sliding guide 32 is displaceable along the slotted guide 37 between a first and a second detent element. The tilting mechanism 30 is preferably disposed in a rear corner of the cover frame 8, so that the first detent element 84 is formed by a section of the cover frame 8 (see FIG. 25). The second detent element is formed by a slide detent 38 which in terms of the slotted guide track 371 of the slotted guide 37 lies opposite the first detent element.

In this context, it is pointed out that terms such as “top”, “bottom”, “front”, “rear”, “top side”, “bottom side”, “front edge”, “rear edge” relate to an operational alignment of the respective components according to the representation of the vehicle roof 1 shown in FIG. 1. Accordingly, the cover frame 8 has two rear corners which are mutually opposite in terms of the longitudinal axis L. If the longitudinal axis L forms a symmetrical central axis of the vehicle roof 1, then the described components of the tilting mechanism 30 are preferably also formed and disposed as mirror images on the other side of the vehicle roof 1. The same applies in an analogous manner to the components of the cover centering unit 20 and the cover receptacle unit 10 as well as the components of the cover system 2 described below, which preferably contribute toward a symmetrical structure in terms of the longitudinal axis L.

The slotted guide track 371 is, for example, configured to be closed on one side and, alternatively or additionally to a rear corner of the cover frame 8, provides a terminal detent for the travel of the deployment lever 31. The slide detent 38 is configured, for example, in such a way that it engages by way of a protruding region in an open end of the slotted guide track 371 of the slotted guide 37 and delimits the latter in a predefined manner on one side (see FIGS. 15 and 17).

The tilting mechanism 30 described has an uncomplicated and compact design, which can moreover be manufactured very inexpensively with a small number of components. In particular, the tilting mechanism 30 enables the front cover 6 to be deployed and retracted without the need for a long guide rail, which usually extends in each case laterally along almost the entire longitudinal struts 82 of the cover frame 8. Moreover, by using the tilting mechanism 30 there is no additional deck support required as a tolerance compensation element, as a result of the pivot point or the first pivot axis S1 of the tilting mechanism 30 being attached to the connection between the mechanism and the cover 6. Corresponding compensation takes place in a bearing slot of the sliding guide 32 or the slotted guide 37 in a cost-neutral manner.

In this way, a particularly space-saving construction of the tilting mechanism 30 can be realized, which has an advantageous effect on the largest possible view through the cover 6 and the vehicle roof 1. This can further be achieved in that the tilting mechanism 30 is designed in particular in coordination with a drive unit 40 of the cover system 2, by means of which the sliding guide 32 can be directly driven in a coupled manner.

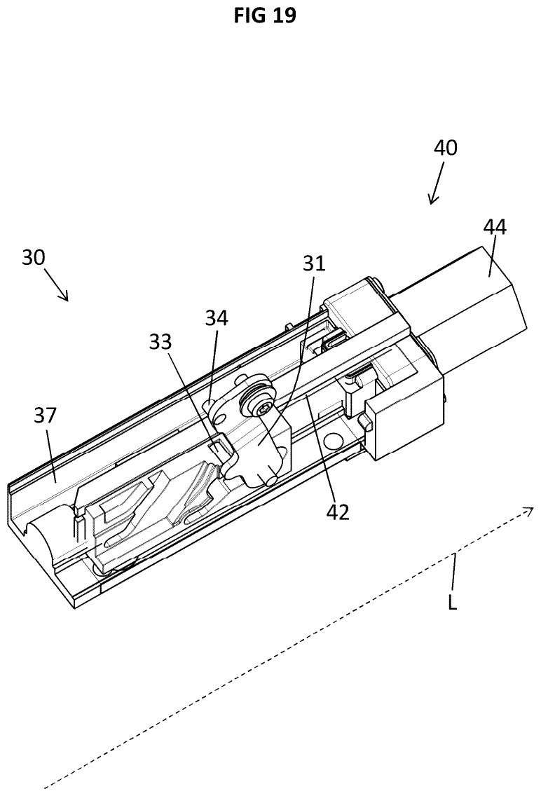

The cover system 2 furthermore comprises the drive unit 40 which interacts advantageously, in particular when interacting with the tilting mechanism 30. FIG. 18 shows an exemplary embodiment of the drive unit 40 in a perspective view. FIGS. 19-25 show further embodiments and/or views of the drive unit 40.

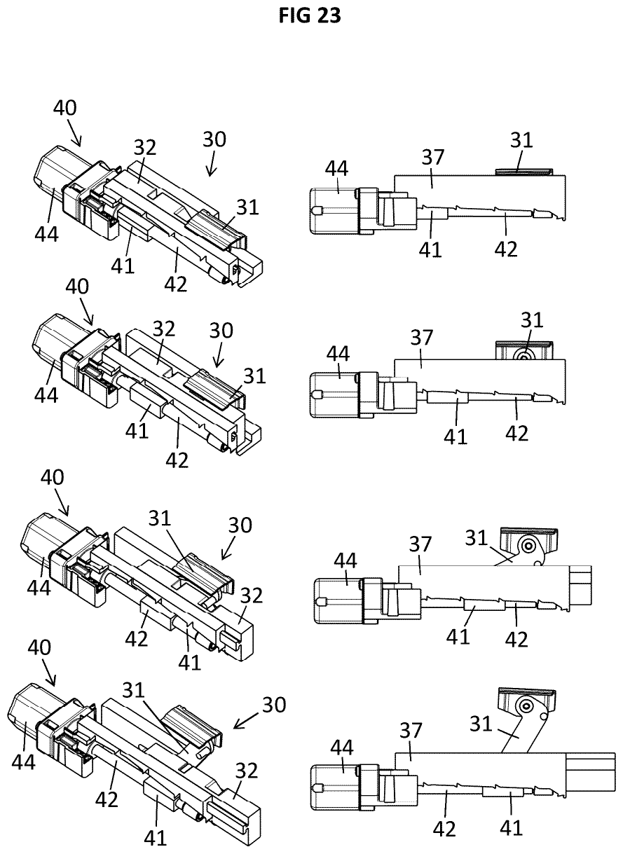

The drive unit 40 as an electric drive is configured to drive the tilting mechanism 30 directly, in particular without a drive cable. The cover 6 is therefore electrically adjustable between the first and the second position Z1, Z2 without a drive cable, while using the drive unit 40 and the tilting mechanism 30. According to the illustrated exemplary embodiments, the drive unit 40 is configured as a spindle drive with a motor 44 and a driving spindle 42, by means of which the drive unit 40 is coupled directly to the tilting mechanism 30. This can be realized by a drive coupling element 41 which, for example in the form of a spindle nut, drives the sliding guide 32 and causes the deployment lever 31 of the tilting mechanism 30 to be deployed and retracted (see FIGS. 19 and 23).

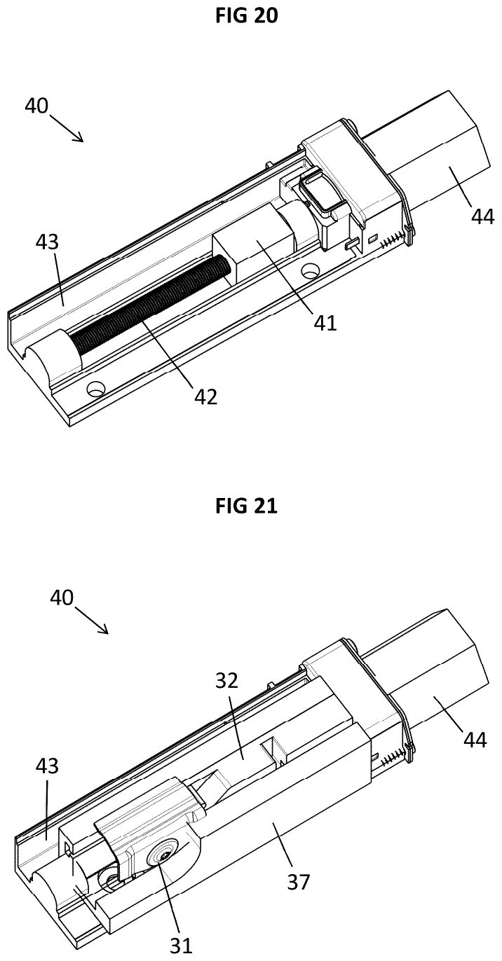

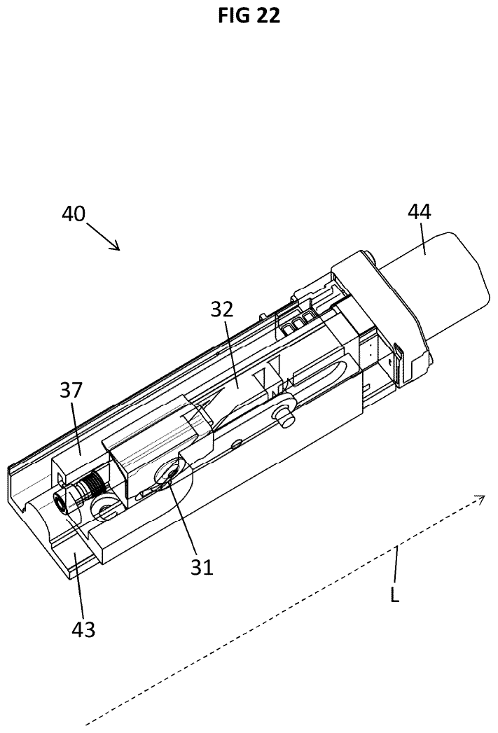

The tilting mechanism 30 can be mounted in a common mount 43 of the drive unit 40 in a manner adapted to the drive unit 40, as is illustrated in FIGS. 20 and 21. Alternatively, the drive unit 40 can form a separate assembly, which is coupled to the slotted guide 37 of the tilting mechanism 30 (see FIG. 19). In particular, the tilting mechanism 30 and the drive unit 40 may be integrated so that they share components. The drive element 41 and the slotted guide 37, which can serve as a bearing for the drive unit 40 in addition to guiding the sliding guide 32, for example, form parts of the tilting mechanism 30 and the drive unit 40, for example (see FIGS. 22 and 23). A particularly space-saving construction of the tilting mechanism 30 and the drive unit 40 can thus be implemented, which contributes toward a large view through the vehicle roof 1 and also provides a ventilation function that can be comfortably actuated.

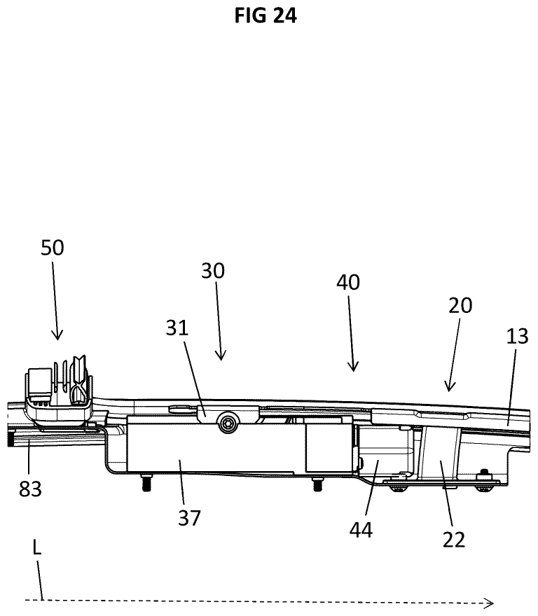

Preferably, as illustrated in FIGS. 24-26, a drive unit 40 on a respective lateral longitudinal strut 82 of the cover frame 8 is coupled to the latter and to an associated tilting mechanism 30. The drive unit 40 is installed in the respective rear corner of the cover frame 8 in such a way that the motor 44 of the respective drive unit 40 faces the front of the vehicle roof 1 or the motor vehicle. The cover system 2 therefore comprises a two-motor concept, as is illustrated in FIGS. 2, 3 and 26, for example. In particular, if the tilting mechanism 30 and the drive unit 40 are used only for deploying and retracting the front cover 6, travel paths of the drive unit can be kept very short. The motor 44 can therefore be linked directly to the respective tilting mechanism 30 and drive directly the sliding guide 32. Thus, a space in the vehicle roof 1 can be left free at the front or rear and can be used for an increased view compared to conventional concepts which comprise long guide rails and drive cables. The installation space directly in front of or behind a deployment mechanism is often vacant so that this position can be used beneficially for disposing the motor 44 of the drive unit 40, having little or no effect on a view through the vehicle roof 1.

The tilting mechanisms 30, which are installed on the right and left or on opposite sides of the vehicle roof 1, can advantageously be synchronized electronically via a motorized actuation of the respective drive unit 40. A complex mechanical synchronization via drive cables can thus be dispensed with. In addition, a bearing or a bracket of the tilting mechanism 30 can at the same time also represent a motor housing or a motor support of the drive unit 40. The drive unit 40 may further include a gearbox and/or a clutch which are/is disposed between the spindle 42 and a shaft of the motor 44.

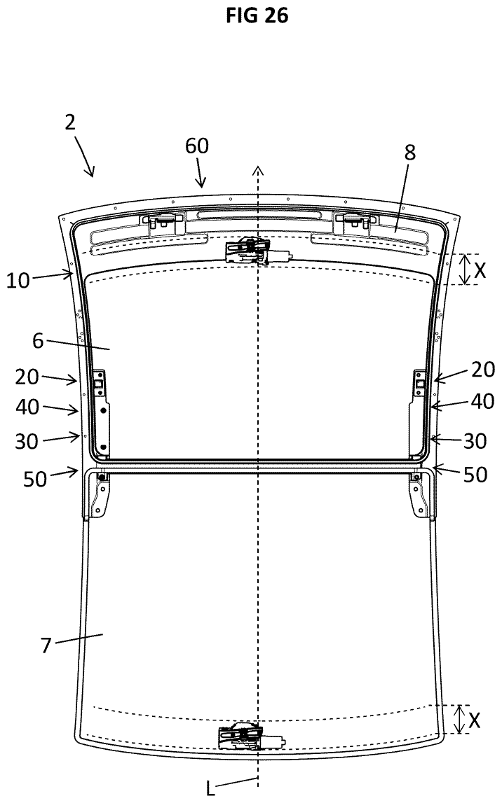

The drive unit 40, in particular in the context of the tilting mechanism 30 described above, makes it possible to dispense with drive cables, frame parts and cable guides or guide tubes. Accordingly, a considerable gain in installation space can be achieved, in particular in the region at the front of the vehicle roof 1 that is particularly relevant for a clear view. Such a gain in installation space and view is indicated in FIG. 26 by the region X, which is installed in a vehicle roof at the front and/or rear in a conventional actuation and deployment concept of a cover.

The drive unit 40 and the tilting mechanism 30 also enable cost savings due to the small number of components and provide a greater freedom of design for mechanical concepts. In addition, a reliable cover retraction of the front cover 6 can take place via simple motor parameterization of the respective drive unit 40 instead of requiring mechanical retraction elements. In addition, the drive unit 40 and the tilting mechanism 30 contribute toward simpler assembly and an improvement in the acoustics of the cover system 2, which are due to the elimination of drive cables and the corresponding cable noises.

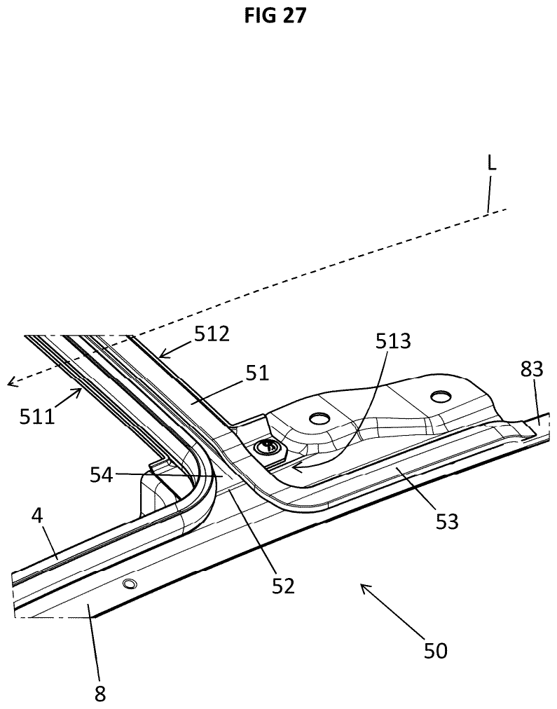

The cover system 2 also includes a sealing assembly 50 which reliably seals an intermediate space between the rear edge 9 of the front cover 6 and a front edge 71 of the rear cover 7 (see FIGS. 27-29). The cover seal 4 together with an adhesive track 53 and a cross strut 51 forms a channel which establishes a water channel 54 for draining water.

The adhesive track 53 is configured to couple the second cover 7 to the cover frame 8 and the cross strut 51. The cross strut 51 in terms of the longitudinal axis L is coupled, for example screwed and/or adhesively bonded, to the cover frame 8 on opposite sides. The cover frame 8 is preferably configured to be U-shaped. The cross strut 51 connects the lateral longitudinal struts 82 of the cover frame 8. Optionally, the cover frame 8 can also have a rear cross strut in addition to the front cross strut 81, which can contribute toward a particularly stable cover frame 8.

The sealing assembly 50 moreover comprises on a respective vehicle roof side a permanently plastic sealant element 52, which is designed in particular as a butyl track and applied in a predefined manner. The cover seal 4 is coupled to the cross strut 51 on a front side 511 of the latter. The adhesive track 53 is coupled to the cross strut 51 on a rear side 512 of the latter. Thus, the cover seal 4, the adhesive track 53 and the cross strut 51 form the water channel 54. The cover seal 4 and the adhesive track 53 are in each case furthermore coupled to the cover frame 8 at opposite peripheral regions 513 of the cross strut 51. The respective sealant element 52 is disposed in the associated peripheral region 513 of the cross strut 51 and is coupled in a sealing manner to the latter and to the cover frame 8, the cover seal 4 and the adhesive track 53. An intermediate space between the cross strut 51, the cover frame 8, the cover seal 4 and the adhesive track 53 is thus reliably sealed against undesired ingress of water by the sealant element 52.

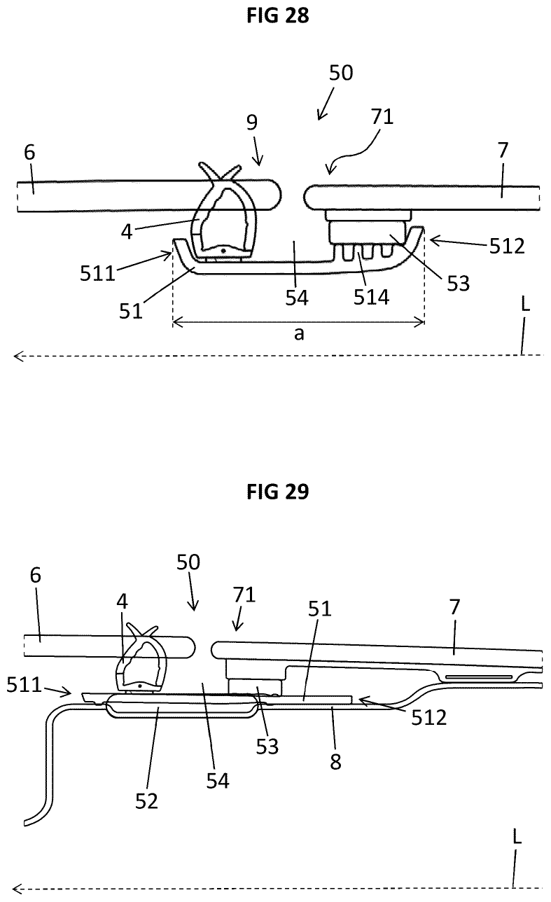

According to the exemplary embodiment according to FIG. 28, the cross strut 51 on an upper side can have a plurality of coupling ribs 514 which extend in the adhesive track 53 and contribute toward the rear cover 7 being reliably coupled to the cross strut 51. The encircling cover seal 4 for the front cover 6 can also be connected to the cross strut 51 on an upper side of the latter, in particular be adhesively bonded thereto. FIG. 29 shows a further possible embodiment of the sealing assembly 50.

The cross strut 51 is in particular made of plastic, or comprises plastic, and forms a component for the vehicle roof 1 that is visible from the vehicle interior of the motor vehicle. In particular, the cross strut 51 can also be designed as a material composite made of glass fiber reinforced tapes. The cross strut 51 is designed to be particularly narrow in order to conceal the transition between the covers 6 and 7 and moreover to provide a visually appealing aspect and to contribute toward enhanced comfort in the vehicle interior. According to the illustration according to FIG. 28, the cross strut 51 in the direction of the longitudinal axis L has only a dimension a of, for example, 40 mm, 45 mm or 50 mm. A particularly narrowly concealed cover transition and moreover a reliably sealed water drainage can thus be achieved by means of the sealing assembly 50. This enables a particularly large view through the vehicle roof 1, or the covers 6 and 7, respectively.

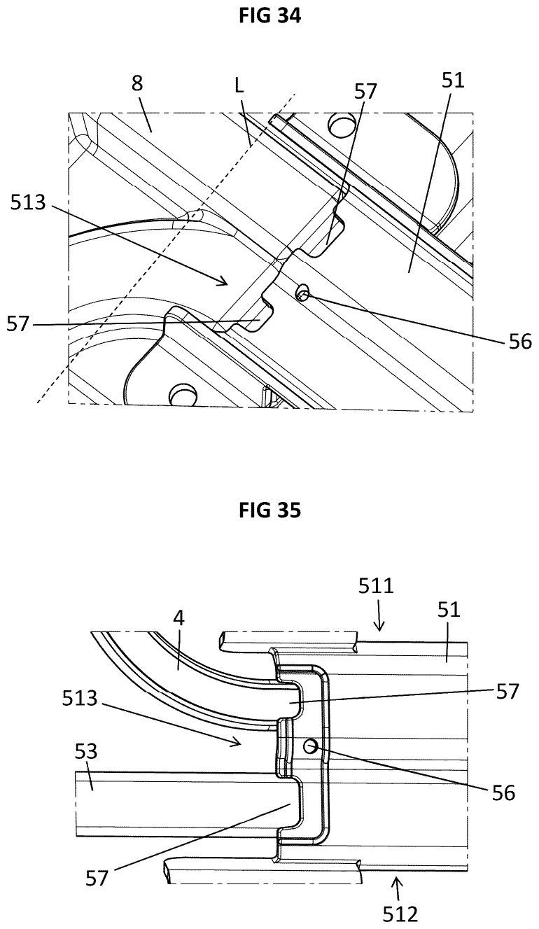

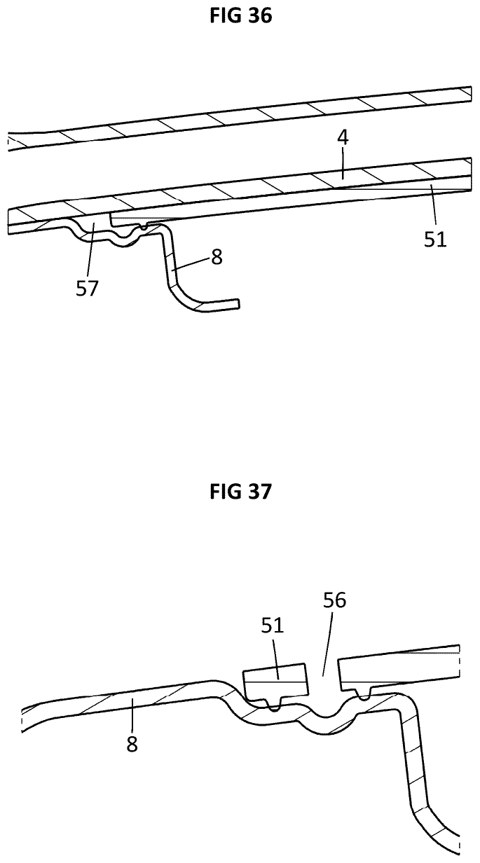

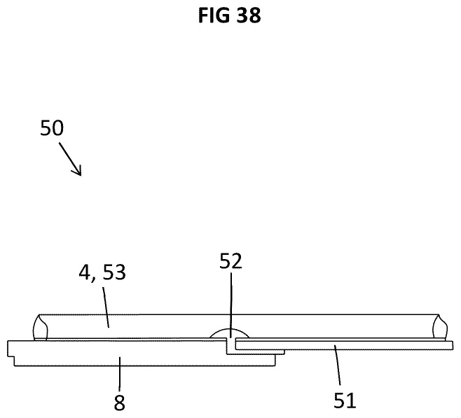

In order for the sealing assembly 50 to be configured, the cross strut 51 can have one or a plurality of injection channels 56 and control openings or outlet openings 57 at predefined positions, by means of which the sealant for forming the sealant element 52 is injected and applied (see FIGS. 34-37).

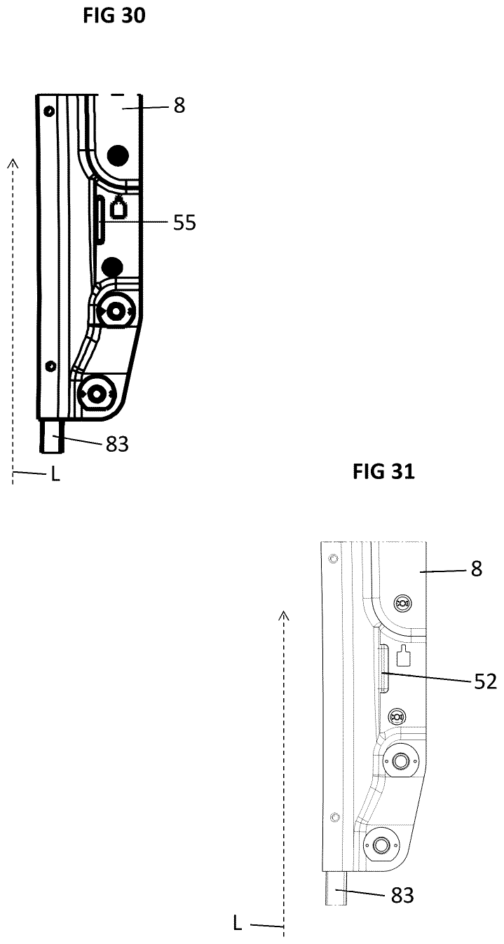

FIGS. 30-33 show different positions of a possible production method for forming the sealing assembly 50. In one step, the components described above, such as the cover frame 8, the cover seal 4, the adhesive track 53 and the cross strut 51, are provided. The cover frame 8 can be provided with a recess that forms a sealant receptacle 55 in which the sealant is applied and the sealant element 52 is formed (see FIGS. 30 and 31). In particular, this can comprise injecting or applying the sealant material in the form of hot butyl and forming a butyl track that implements a preferred design embodiment of the sealant element 52.

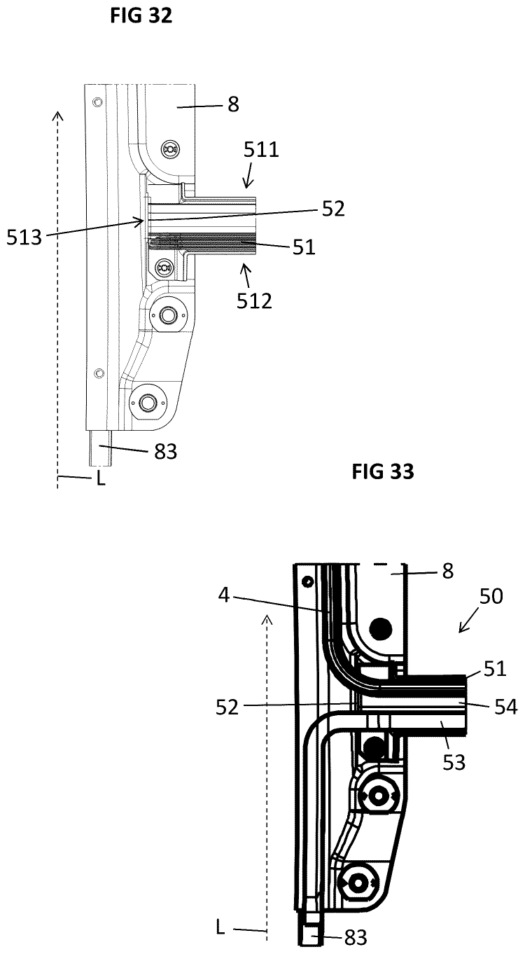

In a further step, the cross strut 51 is mechanically coupled to the cover frame 8 and pressed into the applied butyl track (see FIG. 32). To ensure adequate indentation and reliable sealing, the butyl track is preferably configured with a defined projection, into which the cross strut 51 and other components can be pressed.

In a further step, the cover seal 4 and/or the adhesive track 53 are coupled, in particular adhesively bonded, to the cross strut 51 and the cover frame 8 and thereby pressed into the applied butyl track (see FIG. 33).

Components are pressed into the butyl track in particular when the sealant is in a heated or soft state, so that a beneficial adaptation to the shape of the components to be impressed can be achieved. If the butyl track is applied in front of the cross strut 51, it is pressed into the butyl track in such a way that a defined excess of material emerges from respective joints. The cover seal 4 is pressed into such a bead, so that a tight connection and minor or no capillaries are formed. The adhesive track 53 is likewise guided over such a bead and pressed into the bead so as to seal the latter, for example by placing the rear cover 7.

Alternatively, the sealing assembly 50 may be produced in a different order or manner. For example, the cross strut 51 in terms of the longitudinal axis L is coupled to the cover frame 8 on opposite sides and a respective cavity is formed, the latter being formed as a sealant receptacle between the cross strut 51 and the cover frame 8. The cover seal 4 can then be disposed on the front side 511 of the cross strut 51 and the cover seal 4 can be coupled to the cover frame 8 on the respective peripheral region 513 of the cross strut 51.

The adhesive track 53 is applied to the rear side 512 of the cross strut 51. This can be done with or without the rear cover 7, so that the rear cover 7 is connected to the adhesive track 53 beforehand or afterwards. The adhesive track 53 is applied to the respective peripheral region 513 of the cross strut 51 on the cover frame 8 so that the cover seal 4, the adhesive track 53 and the cross strut 51 establish the predefined channel which realizes the water channel 54 for draining water.

The permanently plastic sealant can then be injected into the respective cavity and the sealant element 52 can be formed. This can be carried out in particular with the aid of the injection channel or channels 56 and control or outlet openings 57. It is preferably checked whether joints between the cross strut 51 and the cover frame 8 and the cover seal 4 and/or the adhesive track 53 have been completely wetted with butyl or the sealant.

The cover seal 4 and/or the adhesive track 53 can thus be coupled to the cross member 51 and the cover frame 8 before or after the injection or application of the sealant.

The sealing assembly 50 described allows the installation space requirements of the water channel 54 between the covers 6 and 7 to be kept very minor. In comparison to conventional concepts, the cover frame 8 with the cross strut 51 is designed in multiple parts, the cross strut 51 being mechanically connected to the cover frame 8 and, as a plastic component 51, also fulfilling a visual aspect in the interior design of the vehicle interior.

The encircling cover seal 4 of the front cover 6 and the adhesive track 53 of the rear cover 7 run over the cross strut 51 and together form the water channel 54, which serves to drain water into a wet region of the cover frame 8. The permanently plastic sealant, in particular in the form of a butyl track, provides merely little or no strength contribution to the mechanical connection.

The sealing assembly 50 can be manufactured inexpensively, and this is also already the case with small numbers. It can be flexibly adapted and moreover provides a robust and reliably sealing construction. The sealing assembly 50 is particularly suitable for deployable and retractable covers, such as the front cover 6, which can be of a relatively soft design. A joint between the cover 6 and the cross strut 51 is therefore preferably designed to be very flexible in order to ensure a long service life and contribute toward reliable sealing. Furthermore, by means of the sealing assembly 50, the use of release films or post-processing, as is customary with polyurethane foam encapsulations, can be dispensed with. Accordingly, the sealing assembly 50 is able to be produced in a relatively simple and time-saving process.

The cover system 2 is also designed to be predefined with regard to the overall stiffness of interacting components. In this regard, the deployable and retractable front cover 6 is configured so as to be predefined with a stiffness A, and the fixedly installed rear cover 7 with a stiffness B. The stiffnesses A and B can each relate to the entire cover 6 or 7 or to local portions of the two covers 6 or 7. In particular, the mutually facing cover edges, i.e. the rear edge 9 of the front cover 6 and the front edge 71 of the rear cover 7, are configured with predefined stiffnesses A and B which are adapted to one another. The cross strut 51 also has a predefined stiffness C. The stiffnesses A, B and C can each relate to an overall stiffness of the associated component, or to portions of these components which are designed in a targeted manner with the corresponding stiffness.

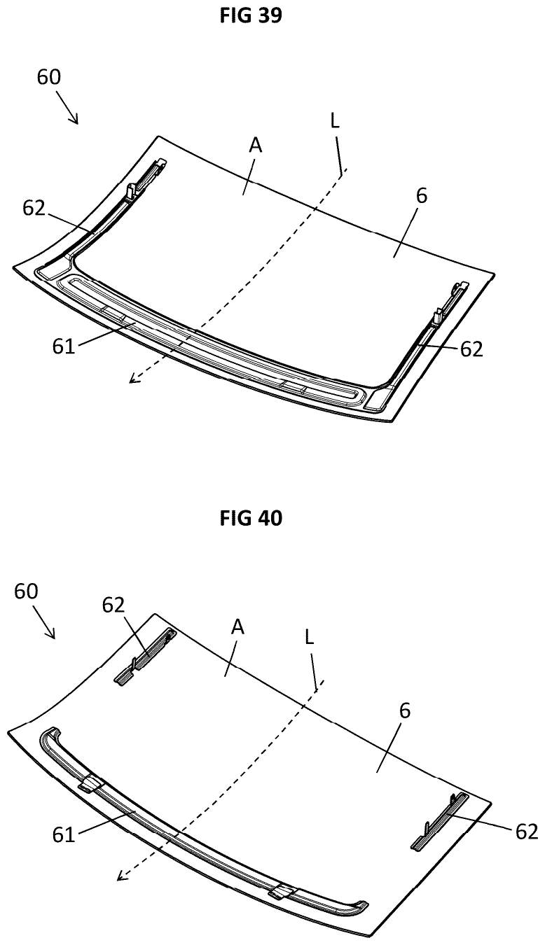

In addition, the cover system 2 includes a reinforcement assembly 60 which includes a U-shaped reinforcement frame with a front cross strut 61 and two lateral longitudinal struts 62. The reinforcement frame 61, 62 can be designed to be contiguous, in particular in one piece, or from a plurality of spaced-apart portions, as is illustrated in the exemplary embodiments according to FIGS. 39 and 40.

The reinforcement frame 61, 62 is disposed in a predefined manner on a lower side of the front cover 6 in order to form the stiffness A of the front cover 6 or to contribute toward the latter in a predefined manner. The reinforcement frame 61, 62 preferably forms the cover inside panel 13 according to FIGS. 6, 11, 12, 16, 17 and 24. In other words, the cover inside panel 13 is configured in such a way that it also forms the reinforcement frame 61, 62 in addition to the functions described above. Alternatively, the reinforcement frame 61, 62 can form an additional reinforcement for the cover inside panel 13 and contribute toward a particularly stable cover system 2.

The reinforcement frame 61, 62 and the stiffnesses A, B, C of the two covers 6, 7 and the cross strut 51 are configured to be mutually adapted so that an upward movement of the covers 6, 7 in a vertical direction perpendicular to a respective plane of main extent of the front and/or the rear cover 6, 7 is deliberately permitted within a predefined tolerance range.

Such a tolerance range may, for example, comprise a movement of the front cover 6 of up to 10 mm and a movement of the rear cover 7 of up to 5 mm. For example, the stiffnesses A, B and C are configured in such a way that movements of the front and/or the rear cover 6, 7 of 12 mm, 14 mm, 16 mm, 18 mm, 20 mm or up to 30 mm, 40 mm or 50 mm are tolerable during the interaction of the components.

Alternatively, the tolerance range can also relate to a movement of the covers 6 and 7 relative to one another, so that the overall stiffness of the cover system 2, which has the effect that a spacing between a lower edge of the front cover 6 and a lower edge of the rear cover 7, which face each other, for example 10 mm or 12 mm or 15 mm is allowed, is achieved.

The permitted and intentionally tolerated upward movement potentials of the cover 6 and/or 7 while the motor vehicle is in motion and the associated negative pressure, the latter being caused by the relative wind and pulling the covers 6 and 7 upwards, are configured in a predefined manner with a view to an overall tight cover system 2.

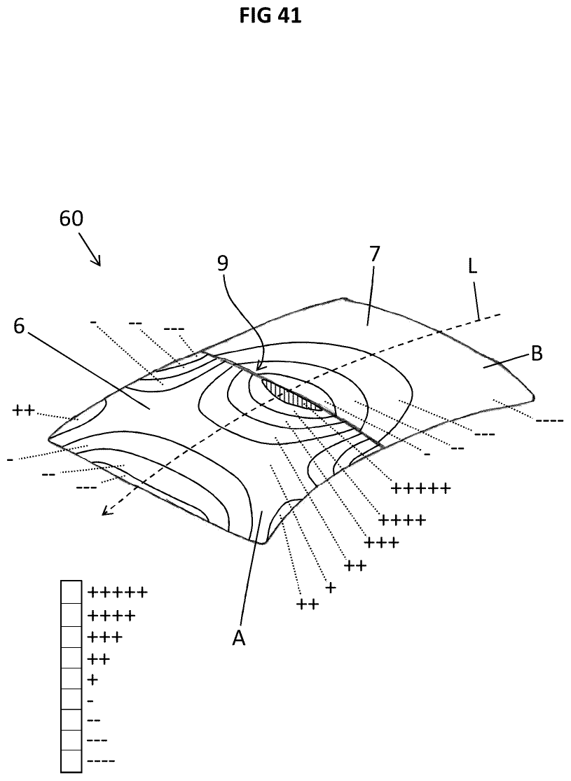

It is a finding in connection with the present invention that while the motor vehicle is driving, locally different suction forces occur on the covers 6 and 7, which pull them upwards. Accordingly, there are different sizes of upward movements of cover sections of the covers 6 and 7. FIG. 41 illustrates the locally dependent wind load that acts on the covers 6 and 7 with specified geometries and properties when the motor vehicle is traveling at a speed of 250 km/h. From this illustration it can be seen that the wind load acting on the front cover 6, which can be deployed and retracted, causes significantly larger upward movements than on the rear, fixed cover 7. The respective upward movements can also be referred to as z-displacements or z-offset according to the coordinate system plotted in FIG. 1.

FIG. 41 shows that the z-offset is greatest at the rear edge 9 of the front cover 6. At this position, the front cover 6 experiences a z-offset of more than 8 mm, for example. A significantly smaller z-offset of, for example, 0.5 mm to 3 mm takes place on a front side and on the sides at the rear corners of the front cover 6. The largest part of the front cover 6 between the previously described positions experiences a z-offset of 3 mm to 6 mm, for example.

The largest part of the rear cover 7 is not imparted any appreciable upward displacement. In a front, central region, an upward z-offset of the rear cover 7 takes place, for example by 0.5 mm or more. At the front edge 71 of the rear cover 7, the latter experiences the greatest z-offset of, for example, more than 3 mm.

Based on such knowledge, the cover system 2 is designed in a targeted manner with regard to its stiffness in such a way that it implements a safe, reliable and tight roof system for the vehicle roof 1 despite such movements. When matching the stiffnesses A, B and C to one another, it is also taken into account that conventional cover reinforcement components cause a significant loss of visibility through a vehicle roof. This is due, for example, to profile geometries, foamed encapsulations and nesting with mechanical concepts. In particular, the separation of two covers in a vehicle roof is usually visually relatively bulky and represents an undesirable interruption of a glass surface in a corresponding vehicle roof. In addition, such components result in reduced headroom due to profile height. These undesired influences can be counteracted by means of a specifically predefined stiffness concept, such as that of the cover system 2 described.

By means of the previously described cover receptacle unit 10 and the tilting mechanism 30, the center of rotation or the pivot axis at the front and the deployment mechanism at the rear are disposed separately from one another on the front cover 6 and are coupled to one another only via the cover reinforcement or the cover inside panel 13 and/or the reinforcement frame 61, 62.

In order to contribute to a particularly large view through the vehicle roof 1 and to take into account possible cover movements, only local reinforcement elements in the form of a U-shaped reinforcement frame 61, 62 are attached to the front cover 6, which is already realized in particular by the cover inside panel 13.

The rear edge 9 of the front cover 6, for example, is deliberately designed to be softer than in conventional configurations and has no additional reinforcement elements. The front cover 6 is thus designed without reinforcement on its rear edge 9. The front edge 71 of the rear cover 7 is also deliberately designed to be soft, for example, and is coupled to the cross strut 51 by means of the adhesive track 53, which as a component also forms the water channel 54 and is used as a seal carrier and compared to the stiffnesses A and B of the two covers 6 and 7 makes no significant contribution toward stiffness. In this way, the least possible loss of visibility in the area of the cover separation between the covers 6 and 7 can be achieved.

The cross strut 51 is preferably designed as a plastic part with a predefined stiffness C. The cross strut 51 can also form a mechanically resilient engagement below the front cover 6 or be designed so soft that it (locally) yields under the sealing pressure that acts when the cover 6 is retracted in the position Z1. The cross strut 51 may also comprise a further element which has a further engagement below the front cover 6 at the front edge 71 of the second cover 7 and is configured to delimit a vertical movement of the second cover 7 and to align the latter with the first cover 6.

By designing the cross strut 51 with the stiffness C and introducing reinforcements in one or both cover edges 9, 71 and in particular by the targeted formation of the stiffnesses A and B in the areas of the cover edges 9 and 71, an overall stiffness in the area of the separation point between the covers 6 and 7 can be checked. Further parameters, such as a respective material, metal inserts, glass thicknesses and glass type, connection to mechanisms and body-in-white, adhesive, PU foam encapsulation, etc., can be taken into account in order to obtain additional degrees of freedom for configuring or influencing the stiffnesses A, B and/or C. In particular, the cross strut 51 can also include tapes as inserts and/or be configured as an organo composite of tapes and/or as an organic sheet, or comprise such a material. An organic sheet, for example, contains carbon fibers which are embedded in a plastic matrix.

The stiffnesses A and B of the two covers 6 and 7 overall are mutually adapted and adjusted in such a way that impermissible movements of the covers 6, 7 relative to one another, such as can occur due to wind load, are avoided or at least counteracted. In particular, the following configurations of the stiffnesses A and B of the covers 6 and 7 can contribute toward a stable and secure cover system 2 with reliable functioning of the covers 6, 7:
1. Stiffnesses A and B are identical; Curvatures of the rear edge 9 of the front cover 6 and the front edge 71 of the rear cover 7 are nominal;
2. Stiffness A is greater than stiffness B; Curvatures of the rear edge 9 of the front cover 6 and the front edge 71 of the rear cover 7 are nominal;
3. Stiffness A is greater than Stiffness B; Curvature of the rear edge 9 of the front cover 6 is nominal and curvature of the front edge 71 of the rear cover 7 is greater;
4. Stiffness B is greater than stiffness A; Curvature of the rear edge 9 of the front cover 6 is flatter and curvature of the front edge 71 of the rear cover 7 is nominal.

Re 1.: It is not necessary for the stiffnesses A and B and the curvatures or convexities of the covers 6 and 7 in the region of the mutually facing cover edges 9 and 71 to be exactly the same or nominal. In this context, the term “nominal” curvature refers to a vehicle transverse convexity of the vehicle roof, so that the covers are curved in accordance with a roof skin contour, for example. By configuring the covers to be arched to a greater or lesser extent, deviating from such a nominal convexity, i.e. having a flatter or higher curvature than the roof skin, a pretension can be built up in a targeted manner when differently curved covers are pressed against each other in order to bring them to a common “nominal” position that is established, for example, when closing. A maximum height of such convexity differences, for example in the y0 direction, can be utilized to ensure reliable sealing of the seal. According to 1., the stiffnesses A and B are approximately identical to a certain extent, so that movements of the covers 6, 7 take place without significant displacements relative to one another, inter alia owing to their cover sizes and their weight. An upward movement of the covers 6 and 7 is therefore deliberately tolerated provided that this and in particular the relative movements take place within a predefined tolerance range.

Re 2.: The rear edge 9 of the front cover 6 is designed to be stiffer than the front edge 71 of the rear cover 7, so that in particular lifting of the rear edge 9 is prevented or counteracted. A corresponding position of the rear edge 9 can be predefined by means of the associated cover mechanism.

Re 3.: The rear edge 9 of the front cover 6 is designed to be stiffer than the front edge 71 of the rear cover 7, and the rear cover 7 is designed to be somewhat excessively convex compared to previous design embodiments. When closing, the front cover 6 then pulls the rear cover 7 into a predefined nominal position. Due to the excessive convexity of the rear cover 7, the cover seal 4 in the retracted position Z1 of the front cover 6 in y0 is compressed more than in previous design embodiments, so that the tightness of the cover system 2 is ensured in the event of a relative displacement of the cover edges 6, 71. One or a plurality of spacers can optionally be provided, for example on an upper side of the cross strut 51, in order to prevent the cover seal 4 from being excessively compressed.

Re 4.: The rear edge 9 of the front cover 6 is designed to be softer than the front edge 71 of the rear cover 7 and is moreover embodied to be flatter. When closing, the front cover 6 is braced over the rear cover 7 and closed to a predefined nominal position. The cover seal 4 is compressed more heavily in y0 than in previous design embodiments, so that the tightness of the cover system 2 is ensured in the event of a relative displacement of the cover edges 9, 71. Optionally, one or a plurality of spacers can also be provided in this configuration, for example on an upper side of the cross strut 51, in order to prevent the cover seal 4 from being excessively compressed. In addition, the front cover 6 pane is preferably somewhat prestressed to prevent detachment from the rear cover 7 pane.

The configurations described and the targeted control of the cover stiffnesses A and B as well as the configuration of the curvatures of the covers 6 and 7 make it possible to save on additional reinforcement elements. Due to the compact construction mode of associated cover mechanisms, such as the tilting mechanism 30 and the drive unit 40, the reinforcement of the cover or covers 6, 7 can follow a customer's body-in-white of the motor vehicle. The view through the vehicle roof 1 can thus be designed to be significantly larger. A width and a height of the separation point between the covers 6, 7 can be significantly reduced by means of the described potential embodiments for the covers 6, 7 and the cross strut 51. This can contribute toward increased view and headroom. In particular, the design of the cross strut 51 as a visible plastic part results in a very small installation space requirement, since additional screens or roof lining elements can be omitted. The cross strut 51 can also be made of steel or a hybrid material or in the form of an organo sheet or have one that includes, for example, carbon fibers that are embedded in a plastic matrix.

By separating the deployment mechanism and the pivot point of the front cover 6, a design without a front panel and guide rails is possible. A particularly large view through the covers 6 and 7 and the vehicle roof 1 can thus be set up, which is typically perceived by customers as appealing and enhancing comfort.

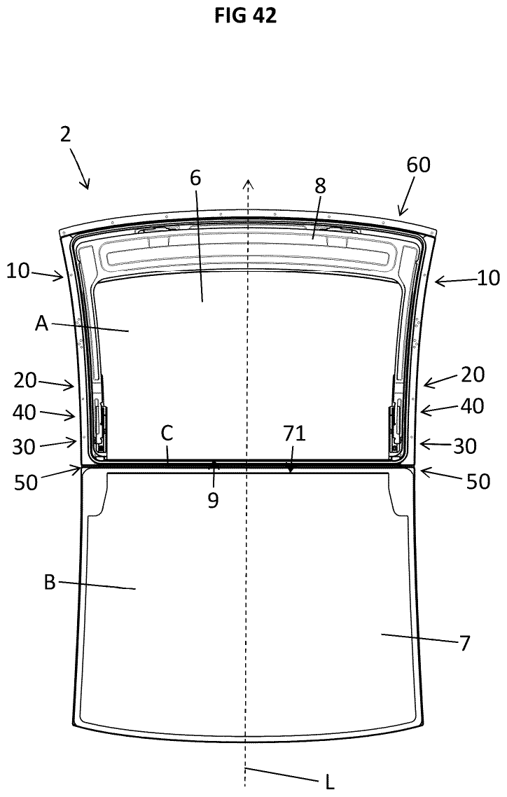

According to a particularly preferred design embodiment, the cover system 2, as illustrated in a multiplicity of the figures, comprises a cover receptacle unit 10, a cover centering unit 20, a tilting mechanism 30, a drive unit 40, a sealing assembly 50 and a reinforcement assembly 60 (see FIG. 42). Alternatively, the cover system 2 can also include only one, two, three, four or five of the components listed above.

A panorama roof can be realized by means of the cover system 2, which in particular enables a top-load front-tilt ventilation concept. The cover system 2 can thus be placed on top and coupled to the roof body 5 and combines a ventilation function with the greatest possible view through the vehicle roof 1. Alternatively, however, the cover system 2 can also be designed for installation from below and implement a so-called “bottom-load” system.

The description includes the following concepts:
1. Assembly for a vehicle roof (1) for a motor vehicle, having:
   a cover (6) for configuring a deployable and retractable roof element for the vehicle roof (1),
   a cover inside panel (13) which is coupled to the cover (6),
   a cover frame (8) which is configured to couple the cover (6) to a roof body (5) of the motor vehicle, and
   a cover receptacle unit (10) which comprises a receptacle element (11) with a receptacle opening (16) and an insertion element (14), the insertion element (14) and the receptacle opening (16) being configured to match one another, one of receptacle element (11) and insertion element (14) in terms of a longitudinal axis (L) of the vehicle roof (1) being coupled to the cover frame (8) on a front cross strut (81) of the latter, and the other of receptacle element (11) and insertion element (14) being coupled to the cover inside panel (13), so that the cover (6) by means of inserting the insertion element (14) into the receptacle opening (16) is able to be coupled to the cover frame (8) and an operationally ready state of the assembly is able to be configured on the front cross strut (81) of the cover frame (8).
2. Assembly according to concept 1, wherein the receptacle element (11) in terms of a cross section along the longitudinal axis (L) of the vehicle roof (1) is of a U-shaped configuration and forms an insertion pocket for the insertion element (14).
3. Assembly according to one of the preceding concepts, wherein the insertion element (14) is formed in one piece with the cover inside panel (13) or the cover frame (8) and is shaped as a bent tab.
4. Assembly according to one of the preceding concepts, having a vibration-damping element (12) which is formed in the region of the receptacle opening (16) and which, in terms of a coupled state of the cover (6) to the cover frame (8) within the receptacle opening (16), exerts a holding force on the insertion element (14).
5. Assembly according to concept 4, wherein the vibration-damping element (12) comprises a plastic overmolding which is formed on an inside (17) of the receptacle element (11) that delimits the receptacle opening (16), so that the plastic overmolding in terms of a coupled state of the cover (6) to the cover frame (8) is disposed between the receptacle element (11) and the insertion element (14).
6. Assembly according to concept 4 or 5, wherein the vibration-damping element (12) comprises a spring element which in the region of the receptacle opening (16) exerts a spring force on the receptacle element (11) in the direction of the receptacle opening (16).
7. Assembly according to one of the preceding concepts, having a plurality of receptacle elements (11) and a plurality of insertion elements (14), which are each disposed and/or configured at a spacing along the front cross strut (81) of the cover frame (8), so that in terms of a coupled state of the cover (6) to the cover frame (8), respective insertion elements (14) are inserted into associated receptacle elements (11).
8. Cover system (2) for a vehicle roof (1), having:
   an assembly according to any one of concepts 1 to 7, and
   a further cover (7), which are in each case coupled to the cover frame (8) such that in terms of the longitudinal axis (L) of the vehicle roof (1), the cover (6) forms a front, deployable roof element and the further cover (7) forms a rear roof element for the vehicle roof (1).
9. Vehicle roof (1) for a motor vehicle, comprising:
   an assembly according to one of concepts 1 to 7 or a cover system (2) according to concept 8, which is coupled to a roof body (5) of the motor vehicle by means of the cover frame (8).
10. Method for producing an assembly for a vehicle roof (1) for a motor vehicle, comprising:
   providing a cover (6) and a cover inside panel (13) and a cover frame (8) which is configured to couple the cover (6) to a roof body (5) of the motor vehicle by means of the cover inside panel (13),
   providing a cover receptacle unit (10) which comprises a receptacle element (11) with a receptacle opening (16) and an insertion element (14), the insertion element (14) and the receptacle opening (16) being designed to match one another, one of receptacle element (11) and insertion element (14) in terms of a longitudinal axis (L) of the vehicle roof (1) being coupled to the cover frame (8) on a front cross strut (81) of the latter, and the other of receptacle element (11) and insertion element (14) being coupled to the cover inside panel (13),
   coupling the cover inside panel (13) to the cover (6), and
   inserting the insertion element (14) into the receptacle opening (16) and thereby coupling the cover (6) to the cover frame (8) and forming an operationally ready state of the assembly on the front cross strut (81) of the cover frame (8).
11. Assembly for a vehicle roof (1) for a motor vehicle, having:
   a cover (6) for configuring a deployable and retractable roof element for the vehicle roof (1),
   a cover inside panel (13) which is coupled to the cover (6),
   a cover frame (8) which is configured to couple the cover (6) to a roof body (5) of the motor vehicle,
   a cover receptacle unit (10) which is designed to receive the cover (6) and to couple the latter to the cover frame (8), and
   a tilting mechanism (30), which comprises a deployment lever (31), a sliding guide (32) and a slotted guide (37),
      the deployment lever (31) being pivotably coupled to the sliding guide (32) on the one hand and thus having a first pivot axis (33), and the deployment lever (31) being pivotably coupled to the cover inside panel (13) on the other hand and thereby having a second pivot axis (39),
      the sliding guide (32) furthermore by means of the slotted guide (37) being coupled to the cover frame (8) so that the sliding guide (32) in terms of a longitudinal axis (L) of the vehicle roof (1) is configured to be displaceable relative to the cover frame (8) and the cover (6) by means of the tilting mechanism (30) is adjustable between a first, retracted position (Z1) and a second, deployed position (Z2), and
      the tilting mechanism (30) being configured such that the second pivot axis (S2) is fixed in position relative to the cover (6) and the first pivot axis (S1) when transferring the cover (6) from the first position (Z1) to the second position (Z2) is displaceable and when reaching the second position (Z2) is fixed in position relative to the sliding guide (32).
12. Assembly according to concept 11, wherein the deployment lever (31) has a first and a second coupling pin (33, 34) and the sliding guide (32) has a first and a second slotted guide track (35, 36) into which a respective coupling pin (33, 34) of the deployment lever (31) engages so that the transfer of the cover (6) from the first position (Z1) to the second position (Z2) is guided by a slotted guide.
13. Assembly according to concept 12, wherein the second coupling pin (34) when transferring the cover (6) from the first position (Z1) to the second position (Z2) decouples from the second slotted guide track (36), while the first coupling pin (33) in the first slotted guide track (35) remains coupled.
14. Assembly according to concept 12 or 13, wherein in terms of a vertical direction perpendicular to a plane of main extent of the cover (6) the second coupling pin (34) when transferring the cover (6) from the first position (Z1) to the second position (Z2) is disposed above the first coupling pin (33).
15. Assembly according to one of the preceding concepts, wherein the deployment lever (31) has a third coupling pin (39) and the slotted guide (37) has a slotted guide track (371) in which the third coupling pin (39) engages, the slotted guide track (371) of the slotted guide (37) in terms of the longitudinal axis (L) of the vehicle roof (1) being delimited in a predefined manner on both sides, and for the third coupling pin (39) establishing a respective terminal detent for configuring the first and the second position (Z1, Z2) of the cover (6).
16. Assembly according to one of the preceding concepts, wherein the sliding guide (32) can be moved along the slotted guide (37) between a first and a second detent element, the first detent element being configured by a portion of the cover frame (8) and the second detent element being configured by a slide detent (38).
17. Assembly according to concept 15 and 16, wherein the slide detent (38) delimits the slotted guide track (371) of the slotted guide (37) on one side.
18. Assembly according to one of the preceding concepts, wherein the sliding guide (32) is coupled to a drive unit (40) so as to be able to be driven directly by the latter.
19. Assembly according to one of the preceding concepts, wherein the cover receptacle unit (10) comprises a receptacle element (11) with a receptacle opening (16) and an insertion element (14), the insertion element (14) and the receptacle opening (16) being configured to match one another, and one of receptacle element (11) and insertion element (14) in terms of the longitudinal axis (L) of the vehicle roof (1) being coupled to the cover frame (8) on a front cross strut (81) of the latter, and the other of receptacle element (11) and insertion element (14) being coupled to the cover inside panel (13), so that the cover (6) by means of inserting the insertion element (13) into the receptacle opening (16) is able to be coupled to the cover frame (8).
20. Assembly according to one of the preceding concepts, comprising:
   a cover centering unit (20) which comprises a centering lever (21) and a lever receptacle (22), which are designed to match one another, one of centering lever (21) and lever receptacle (22) in terms of a longitudinal axis (L) of the vehicle roof (1) being coupled to the cover frame (8) on a lateral longitudinal strut (82) of the latter, and the other of centering lever (21) and lever receptacle (22) being coupled to the cover inside panel (13), so that the cover (6) can be coupled to the cover frame (8) by means of the cover receptacle unit (10) and by means of inserting the centering lever (21) into the lever receptacle (22) in terms of a plane of main extent of the cover (6) is able to be centered relative to the cover frame (8).
21. Assembly for a vehicle roof (1) for a motor vehicle, having:
   a cover (6) for configuring a deployable and retractable roof element for the vehicle roof (1),
   a cover inside panel (13) which is coupled to the cover (6),
   a cover frame (8) which is configured to couple the cover (6) to a roof body (5) of the motor vehicle,
   a cover receptacle unit (10), which is configured to receive the cover (6) and to couple it to the cover frame (8),
   a tilting mechanism (30) which is coupled to the cover inside panel (13) on the one hand and to the cover frame (8) on the other hand, and which is configured to adjust the cover (6) between a first, retracted position (Z1) and a second, deployed position (Z2), and
   an electric drive unit (40) which is coupled directly to the tilting mechanism (30), so that the cover (6) by means of the tilting mechanism (30) and the drive unit (40) is electrically adjustable without a drive cable between the first and the second position (Z1, Z2).
22. Assembly according to concept 21, wherein the drive unit (40) comprises a spindle drive with a motor (44) and a driving spindle (42), by means of which the drive unit (40) is coupled directly to the tilting mechanism (30).
23. Assembly according to one of the preceding concepts, wherein the drive unit (40) comprises a gearbox, by means of which the drive unit (40) is coupled directly to the tilting mechanism (30).
24. Assembly according to one of the preceding concepts, wherein the tilting mechanism (30) and the drive unit (40) are mounted in a common bracket (43).
25. Assembly according to one of concepts 21 to 23, wherein the drive unit (40) forms a separate module which is connected to a mounting (37) of the tilting mechanism (30).
26. Assembly according to one of the preceding concepts, wherein the drive unit (40) in terms of a longitudinal axis (L) of the vehicle roof (1) is coupled to the cover frame (8) on a lateral longitudinal strut (82) of the latter.
27. Assembly according to one of the preceding concepts, wherein the tilting mechanism (30) comprises a deployment lever (31), a sliding guide (32) and a slotted guide (37),
   the deployment lever (31) being pivotably coupled to the sliding guide (32) on the one hand and thus having a first pivot axis (S1), and the deployment lever (31) being pivotably coupled to the cover inside panel (13) on the other hand and thereby having a second pivot axis (S2),
   the sliding guide (32) furthermore by means of the slotted guide (37) being coupled to the cover frame (8) so that the sliding guide (32) in terms of a longitudinal axis (L) of the vehicle roof (1) is configured to be displaceable relative to the cover frame (8), and
   the tilting mechanism (30) being configured such that the second pivot axis (S2) is fixed in position relative to the cover (6) and the first pivot axis (S1) when transferring the cover (6) from the first position (Z1) to the second position (Z2) is displaceable and when reaching the second position (Z2) is fixed in position relative to the sliding guide (32).
28. Assembly according to concept 27, wherein the drive unit (40) is coupled directly to the sliding guide (32) of the tilting mechanism (30).
29. Assembly (50) for sealing an intermediate space between two covers (6, 7) for a vehicle roof (1) for a motor vehicle, having:
   a cover frame (8) which is configured to couple a deployable and retractable first cover (6) and a fixed second cover (7) to a roof body (5) of the motor vehicle,
   a cover seal (4) which is configured to seal a space between the first cover (6) and the cover frame (8),
   an adhesive track (53) which is configured to couple the second cover (7) to the cover frame (8),
   a cross strut (51) which in terms of a longitudinal axis (L) of the vehicle roof (1) is coupled to the cover frame (8) on opposite sides, and
   a permanently plastic sealant element (52),
      the cover seal (4) being coupled to the cross strut (51) on a front side (511) thereof,
      the adhesive track (53) being coupled to the cross strut (51) on a rear side (512) thereof, so that the cover seal (4), the adhesive track (53) and the cross strut (51) establish a predefined channel which configures a water channel (54) for draining water,
      the cover seal (4) and the adhesive track (53) each also being coupled to the cover frame (8) at a respective peripheral region (513) of the cross strut (51), and
      the sealant element (52) being in each case disposed in the peripheral region (513) of the cross strut (51) and being coupled in a sealing manner to the latter and to the cover frame (8), the cover seal (4) and the adhesive track (53).
30. Assembly (50) according to concept 29, wherein the cross strut (51) has an injection channel (56) and an outlet opening (57), by means of which sealant for forming the sealant element (52) is injected and applied at a predefined position.
31. Assembly (50) according to one of the preceding concepts, wherein the cover frame (8) has a recess which configures a sealant receptacle (55) in which the sealant element (52) is applied.
32. Assembly (50) according to one of the preceding concepts, wherein the sealant element (52) is formed from butyl or comprises butyl.
33. Assembly (50) according to one of the preceding concepts, wherein the cross strut (51) has a plurality of coupling ribs (514) by means of which the cross strut (51) is connected to the adhesive track (53).
34. Assembly (50) according to one of the preceding concepts, wherein the cross strut (51) is made of plastic or comprises plastic and is configured as a predefined component for the vehicle roof (1), which is visible from a vehicle interior of the motor vehicle.
35. Method for producing an assembly (50) for sealing an intermediate space between two covers (6, 7) for a vehicle roof (1) for a motor vehicle, comprising the following method steps:
   providing a cover frame (8), which is configured to couple a deployable and retractable first cover (6) and a fixed second cover (7) to a roof body (5) of the motor vehicle,
   providing a cover seal (4) which is configured to seal a space between the first cover (6) and the cover frame (8),
   providing a cross strut (51),
   coupling the cross strut (51) to the cover frame (8) so that the cross strut (51) in terms of a longitudinal axis (L) of the vehicle roof (1) is coupled to the cover frame (8) on opposite sides and a respective cavity (55) is formed between the cross strut (51) and the cover frame (8),
   disposing the cover seal (4) on a front side (511) of the cross strut (51) and coupling the cover seal (4) on a respective peripheral region (513) of the cross strut (51) to the cover frame (8),
   applying an adhesive track (53) to a rear side (512) of the cross strut (51) and on a respective peripheral region (513) of the cross strut (51) to the cover frame (8), so that the cover seal (4), the adhesive track (53) and the cross strut (51) establish a predefined channel which configures a water channel (54) for draining water, and
   incorporating permanently plastic sealant into the respective cavity (55) and forming a respective sealant element (52) which is disposed in the respective peripheral region (513) of the cross strut (51) and is coupled in a sealing manner to the latter and to the cover frame (8), the cover seal (4) and the adhesive track (53).
36. Method according to concept 35, wherein the injecting of permanently plastic sealant comprises:
   injecting hot butyl and forming a respective sealant element (52).
37. Method according to concept 35 or 36, wherein the cover seal (4) and/or the adhesive track (53) are/is coupled to the cross member (51) and the cover frame (8) before the sealant is injected.
38. Method according to concept 35 or 36, wherein the cover seal (4) and/or the adhesive track (53) are coupled to the cross member (51) and the cover frame (8) and pressed into the injected sealant after the sealant has been injected.
39. Method according to one of concepts 35, 36 or 38, comprising:
   applying the sealant to the cover frame (8) at opposite positions in terms of the longitudinal axis (L), subsequently
   fitting the cross strut (51) to the cover frame (8) and pressing the cross strut (51) into the respectively applied sealant, and subsequently
   disposing the cover seal (4) and applying the adhesive track (53) and pressing the cover seal (4) and the adhesive track (53) into the respective sealant applied.
40. Cover system (2) for a vehicle roof (1), having:
   an assembly (50) according to one of the preceding concepts, and
   a first, deployable and retractable cover (6) and a second, fixed cover (7), which are in each case coupled to the cover frame (8) so that in terms of a longitudinal axis (L) of the vehicle roof (1), the first cover (6) forms a front roof element and the further cover (7) forms a rear roof element for the vehicle roof (1).
41. Cover system (2) for a vehicle roof (1) for a motor vehicle, having:
   a deployable and retractable first cover (6), which has a predefined stiffness (A),
   a fixed second cover (7) which has a predefined stiffness (B),
   a cover frame (8) which is coupled to the two covers (6, 7) and is configured to couple the covers (6, 7) to a roof body (5) of the motor vehicle,
   a cross strut (51), which has a stiffness (C) of predefined configuration and in terms of a longitudinal axis (L) of the vehicle roof (1) is coupled to the cover frame (8) on opposite sides and is disposed between a rear edge (9) of the first cover (6) and a front edge (71) of the second cover (7), and
   a reinforcement assembly (60) comprising a U-shaped reinforcement frame (61, 62) which is coupled to the first cover (6), the reinforcement frame (61, 62) and the stiffnesses (A, B, C) of the two covers (6, 7) and the cross strut (51) being configured to be mutually adapted in such a way that a movement of the covers (6, 7) in a vertical direction perpendicular to a respective main plane of extent of the first and/or second cover (6, 7) is permitted within a predefined tolerance range.
42. Cover system (2) according to concept 41, wherein the predefined tolerance range comprises a movement of the first cover (6) of up to 10 mm and a movement of the second cover (7) of up to 5 mm in the vertical direction perpendicular to a respective main plane of extent of the first and/or second cover (6, 7).
43. Cover system (2) according to one of the preceding concepts, wherein the rear edge (9) of the first cover (6) is configured to be stiffer than the front edge (71) of the second cover (7), so that the stiffness (A) of the first cover (6) is greater than the stiffness (B) of the second cover (7).
44. Cover system (2) according to concept 41 or 42, in which the front edge (71) of the second cover (7) is designed to be stiffer than the rear edge (9) of the first cover (6), so that the stiffness (A) of the first cover (6) is smaller than the stiffness (B) of the second cover (7).
45. Cover system (2) according to one of the preceding concepts, wherein the reinforcement assembly (60) comprises a cross strut (61) and two longitudinal struts (62) which in terms of the longitudinal axis (L) are connected to the first cover (6) on opposite sides, so that the rear edge (9) of the first cover (6) is designed without reinforcement.
46. Cover system (2) according to one of the preceding concepts, wherein the first cover (6) in a set state (Z1) on the rear edge (9) is coupled to the cross strut (51) by means of a cover seal (4) which is configured to seal a space between the first cover (6) and the cover frame (8), and wherein the second cover (7) at the front edge (71) is coupled to the cross strut (51) by means of an adhesive track (53) which is configured to connect the second cover (7) to the cover frame (8), so that the cover seal (4), the adhesive track (53) and the cross strut (51) establish a predefined channel which forms a water channel (58) for draining water.
47. Cover system (2) according to concept 46, having: a spacer which is coupled to the cross strut (51) or the first cover (6) and which is configured to counteract excessive compression of the cover seal (4) when the cover (6) is in the retracted state (Z1).
48. Cover system (2) according to one of the preceding concepts, wherein the cross strut (51) is made of plastic or comprises plastic, so that the stiffness (C) of the cross strut (51) is significantly less than the stiffness (A, B) of the first and the second cover (6, 7).
49. Cover system (2) according to one of the preceding concepts, wherein the stiffnesses (A, B) of the covers (6, 7) in terms of the vertical direction perpendicular to their respective plane of main extent by means of a respective convexity, are predefined by configuring a respective thickness and/or a respective material of the covers (6, 7).
50. Vehicle roof (1) for a motor vehicle, comprising: an assembly (50) according to one of the preceding concepts or a cover system (2) according to one of the preceding concepts, which is coupled to a roof body (5) of the motor vehicle by means of the cover frame (8).

1. An assembly for a vehicle roof for a motor vehicle, having:
a cover for configuring a deployable and retractable roof element for the vehicle roof,
a cover inside panel which is coupled to the cover,
a cover frame which is configured to couple the cover to a roof body of the motor vehicle,
a cover receptacle unit which is designed to receive the cover and to couple the latter to the cover frame, and
a cover centering unit which comprises a centering lever and a lever receptacle, which are configured to match one another, one of centering lever and lever receptacle in terms of a longitudinal axis of the vehicle roof being coupled to the cover frame on a lateral longitudinal strut of the latter, and the other of centering lever and lever receptacle being coupled to the cover inside panel so that the cover can be coupled to the cover frame by the cover receptacle unit and by inserting the centering lever being able to be centered in the lever receptacle in relation to a plane of main extent of the cover relative to the cover frame, an aligned and operationally ready state of the assembly being able to be formed thereby.

2. The assembly according to claim 1, wherein the centering lever is configured to be integral to the cover inside panel or the cover frame and is shaped as a bent tab.

3. The assembly according to claim 1, wherein the lever receptacle is configured in the shape of a sleeve.

4. The assembly according to claim 1, wherein the cover centering unit comprises a vibration-damping element which is coupled to the lever receptacle and, in terms of a coupled state of the cover to the cover frame, counteracts any vibration of the centering lever.

5. The assembly according to claim 4, in which the vibration-damping element comprises a plastic encapsulation, which is formed on an inner side of the lever receptacle facing the centering lever, so that the plastic encapsulation, based on a coupled state of the cover with the cover frame, is disposed between the centering lever and the lever receptacle.

6. The assembly according to claim 1, wherein the cover is configured as a deployable and retractable roof element that can be raised and lowered at a rear edge, the cover receptacle unit being disposed on a front cross strut of the cover frame and forming a pivot axis of the cover when the cover is coupled to the cover frame, and wherein the centering lever and the lever receptacle are designed to match the pivot axis in terms of orientation, position and/or shape.

7. The assembly according to claim 1, wherein the cover is configured as a deployable and retractable roof element that can be raised and lowered at a rear edge and has a predefined convexity in terms of its plane of main extent, the centering lever and the lever receptacle being designed to match the convexity of the cover in terms of orientation, position and/or shape.

8. The assembly according to claim 1, wherein the cover receptacle unit comprises a receptacle element with a receptacle opening and an insertion element, the insertion element and the receptacle opening being configured to match one another, and one of receptacle element and insertion element in terms of the longitudinal axis of the vehicle roof being coupled to the cover frame on a front cross strut of the latter, and the other of receptacle element and insertion element being coupled to the cover inside panel, so that the cover by means of inserting the insertion element into the receptacle opening is able to be coupled to the cover frame.

9. A cover system for a vehicle roof, having:
an assembly according to claim 1, and
a further cover, which is coupled to the cover frame so that in terms of the longitudinal axis of the vehicle roof, the cover forms a front roof element and the further cover forms a rear roof element for the vehicle roof.

10. A vehicle roof for a motor vehicle, comprising:
an assembly according to claim 1, which is coupled to a roof body of the motor vehicle by means of the cover frame.

11. A method for producing an assembly for a vehicle roof for a motor vehicle, comprising:
providing a cover and a cover inside panel and a cover frame which is designed to couple the cover to a roof body of the motor vehicle by means of the cover inside panel,
providing a cover receptacle unit, which is designed to receive and couple the cover to the cover frame,
providing a cover centering unit with a centering lever and a lever receptacle, the centering lever and the lever receptacle being configured to match one another, one of centering lever and lever receptacle in terms of a longitudinal axis of the vehicle roof being coupled to the cover frame on a lateral longitudinal strut of the latter, and the other of centering lever and lever receptacle being coupled to the cover inside panel,
coupling the cover inside panel to the cover,
coupling the cover to the cover frame by means of the cover receptacle unit, and
inserting the centering lever into the lever receptacle and thereby centering the cover relative to the cover frame in terms of a plane of main extent of the cover and forming an aligned and operationally ready state of the assembly.

12. The method according to claim 11, comprising:
providing the cover receptacle unit which comprises a receptacle element with a receptacle opening and an insertion element, the insertion element and the receptacle opening being designed to match one another and one of receptacle element and insertion element in terms of the longitudinal axis of the vehicle roof being coupled to the cover frame on a front cross strut of the latter, and the other of receptacle element and insertion element being coupled to the cover inside panel, and
coupling the cover to the cover frame by means of the cover receptacle unit by inserting the insertion element into the receptacle opening.
